(19) United States
(12) Patent Application Publication
(10) Pub. No.: US 2020/0022214 A1
(43) Pub. Date: Jan. 16, 2020

(54) USER EQUIPMENT AND DATA TRANSMISSION METHOD

(71) Applicant: NTT DOCOMO, INC., Tokyo (JP)

(72) Inventors: Hideaki TAKAHASHI, Tokyo (JP); Tooru UCHINO, Tokyo (JP); Wuri Andarmawanti HAPSARI, Tokyo (JP); Yousuke SANO, Tokyo (JP); Kazuaki TAKEDA, Tokyo (JP)

(73) Assignee: NTT Docomo, Inc., Tokyo (JP)

(21) Appl. No.: 16/335,718

(22) PCT Filed: Sep. 29, 2017
(86) PCT No.: PCT/JP2017/035514

§ 371 Date: Mar. 22, 2019

(30) Foreign Application Priority Data
Sep. 29, 2016 (JP) 2016-192358

(51) Int. Cl. H04W 88/02; H04W 74/02; H04W 74/08; H04W 76/11; H04W 76/19; H04W 76/27

(52) U.S. Cl. CPC H04W 88/023; H04W 74/02; H04W 76/27; H04W 76/11; H04W 76/19; H04W 74/0833

(57) ABSTRACT

A user equipment that is used in a wireless communication system supporting an intermediate state between a connected state and an idle state includes: a comparison unit that, when uplink data is generated in the user equipment in the intermediate state, compares a size of the uplink data with a predetermined upper limit; and a transmitting unit that transmits the uplink data to a base station in a contention-based manner when the comparison unit determines that the size of the uplink data is less than the predetermined upper limit and transmits the uplink data to the base station in a contention-free manner when the comparison unit determines that the size of the uplink data is greater than the predetermined upper limit.

### TECHNICAL FIELD

The present invention relates to a user equipment and a base station in a wireless communication system.

### BACKGROUND ART

In recent years, in the third generation partnership project (3GPP), the next-generation standard (5G or new radio access technology (NR)) of a long term evolution (LTE) system and an LTE-Advanced system has been examined. In 3GPP, the communication state of a user equipment has been examined. In the LTE system and the LTE-Advanced system, the operation of a user equipment in two communication states, that is, an RRC_CONNECTED state and an RRC_IDLE state is defined in radio resource control (RRC) that controls a wireless network (Non-Patent Document 1).

### CITATION LIST

### Non-Patent Document

Non-Patent Document 1: 3GPP TS 36.331 V13.2.0 (2016-06)

### SUMMARY OF THE INVENTION

### Problem to be Solved by the Invention

In contrast, in the NR system, the introduction of an intermediate state between an RRC_CONNECTED state (connected state) and an RRC_IDLE state (idle state) has been examined. In the intermediate state, the connection between a user equipment and a base station is suspended and no individual resources are allocated to the user equipment. However, the connection related to the user equipment is maintained between a core network and the base station.

In the intermediate state, radio parameters (access stratum (AS) context) configured in the connected state are retained in the user equipment and the base station. Therefore, at the time of a transition from the intermediate state to the connected state, it is possible to perform the transition with a small amount of signaling.

Here, an example of the user equipment in the NR (5G) system is a terminal that transmits a small amount of data with low frequency, such as an IoT terminal (for example, a smart meter). It is assumed that a huge number of IoT terminals are provided.

In a case in which a small amount of uplink (UL) data is generated in the user equipment in the intermediate state to which no individual resources are allocated, when signals for acquiring the individual resources (that is, for transition to the connected state) are transmitted and received, power is unnecessarily consumed for the amount of UL data transmitted and NW resources are unnecessarily consumed for the amount of UL data transmitted, which is inefficient. This problem is not limited to the IoT terminal. However, a technique that enables the user equipment to effectively transmit UL data when the UL data is generated in the user equipment in the intermediate state has not been proposed.

The invention has been made in view of the above-mentioned problems and an object of the invention is to provide a technique that enables a user equipment to effectively transmit UL data when the UL data is generated in the user equipment in an intermediate state between a connected state and an idle state.

### Means for Solving Problem

According to the disclosed technique, there is provided a user equipment that is used in a wireless communication system supporting an intermediate state between a connected state and an idle state. The user equipment includes: a comparison unit that, when uplink data is generated in the user equipment in the intermediate state, compares a size of the uplink data with a predetermined upper limit; and a transmitting unit that transmits the uplink data to a base station in a contention-based manner when the comparison unit determines that the size of the uplink data is less than the predetermined upper limit and transmits the uplink data to the base station in a contention-free manner when the comparison unit determines that the size of the uplink data is greater than the predetermined upper limit.

### Effect of the Invention

According to the disclosed technique, there is provided a technique that enables a user equipment to effectively transmit UL data when the UL data is generated in the user equipment in an intermediate state between a connected state and an idle state.

### BRIEF DESCRIPTION OF DRAWINGS

FIG. 1 is a diagram illustrating the structure of a wireless communication system according to an embodiment of the invention;

FIG. 2 is a diagram illustrating an RRC state transition that is premised in the embodiment of the invention;

FIG. 3 is a diagram illustrating the RRC state transition that is premised in the embodiment of the invention;

FIG. 4 is a diagram illustrating a procedure list for a state transition;

FIG. 5 is a diagram illustrating a state transition procedure from an RRC_CONNECTED state to an RRC_INACTIVE state;

FIG. 6 is a sequence diagram illustrating a receiving process in the RRC_INACTIVE state;

FIG. 7 is a sequence diagram illustrating a receiving process in the RRC_INACTIVE state;

FIG. 8 is a sequence diagram illustrating a position registration area update procedure;

FIG. 9 is a diagram illustrating a state transition procedure from the RRC_INACTIVE state to an RRC_IDLE state;

FIG. 10 is a diagram illustrating a CN-RAN connection release procedure during a transition from the RRC_INACTIVE state to the RRC_IDLE state;

FIG. 11 is a diagram illustrating a state transition procedure from the RRC_INACTIVE state to the RRC_IDLE state;

FIG. 12 is a diagram illustrating a state transition procedure from the RRC_INACTIVE state to an NR RRC_IDLE state;

FIG. 13 is a diagram illustrating an example of the flow of the entire process in the embodiment of the invention;

FIG. 14 is a flowchart illustrating the operation of a user equipment 100 in Example 1;

FIG. 15 is a diagram illustrating the outline of a UL data transmission procedure in Example 2-1;

FIG. 16 is a diagram illustrating the outline of a UL data transmission procedure in Example 2-2;

FIG. 17 is a sequence diagram illustrating the UL data transmission procedure in Example 2-1;

FIG. 18 is a sequence diagram illustrating the UL data transmission procedure in Example 2-2;

FIG. 19 is a sequence diagram illustrating a UL data transmission procedure in Example 3;

FIG. 20 is a flowchart illustrating the procedure of a base station 200 determining to instruct the resumption of an RRC connection in Example 3;

FIG. 21 is a diagram illustrating an example of the functional structure of the user equipment 100;

FIG. 22 is a diagram illustrating an example of the functional structure of the base station 200; and

FIG. 23 is a diagram illustrating an example of the hardware configuration of the user equipment 100 and the base station 200.

### MODE(S) FOR CARRYING OUT THE INVENTION

Hereinafter, an embodiment (this embodiment) of the invention will be described with reference to the drawings. The following embodiment is just an example and the embodiment to which the invention is applied is not limited to the following embodiment.

For example, it is assumed that a wireless communication system according to this embodiment supports at least an LTE communication system. Therefore, when the wireless communication system operates, it is possible to appropriately use the existing technique defined in LTE. However, the existing technique is not limited to LTE. In the specification, “LTE” includes LTE-Advanced and systems beyond LTE-Advanced in a wide sense, unless otherwise stated. The invention can also be applied to communication systems other than LTE.

Hereinafter, an intermediate state between a connected state and an idle state is mainly referred to as an INACTIVE state and may be also referred to as a SUSTAINED state. Therefore, the representation “INACTIVE state (SUSTAINED state)” is appropriately used. The INACTIVE state may be restated as a SUSTAINED state even when it is represented without parentheses. In addition, “inactivation” may be restated as “sustenance”. The intermediate state may have other names. Operations in Examples 1 to 3 which will be described below are assumed in the intermediate state. This is just an example and the operations in Examples 1 to 3 which will be described below may be performed in states other than the intermediate state.

(Overall Structure of System)

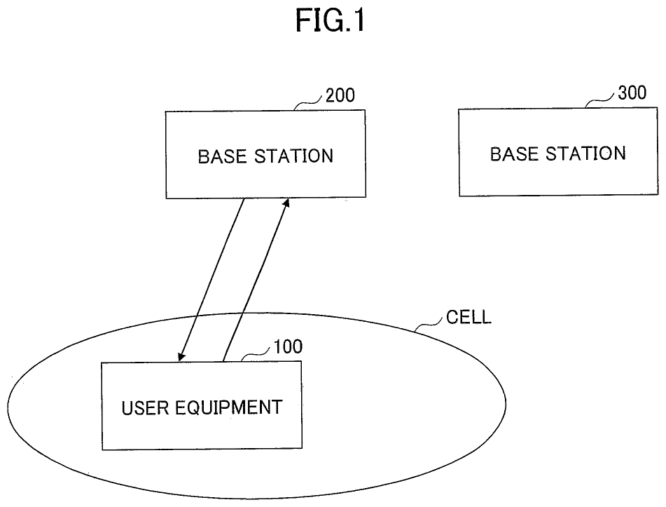

FIG. 1 is a diagram illustrating the structure of a wireless communication system according to this embodiment. As illustrated in FIG. 1, the wireless communication system according to this embodiment includes a user equipment 100, a base station 200, and a base station 300. The base station 300 will be described, for example, when a state transition procedure assumed in this embodiment is described. In FIG. 1, one user equipment 100, one base station 200, and one base station 300 are illustrated. However, this structure is just an example. A plurality of user equipments 100, a plurality of base stations 200, and a plurality of base stations 300 may be provided.

In the wireless communication system according to this embodiment, for example, the base station 200 may be a base station (which may be referred to as an NR node or gNB) based on an NR system (which may be referred to as a 5G wireless system) and the base station 300 may be a base station (evolved NodeB (eNB)) that is not based on the NR system, but is based on an LTE system. In the following description, it is assumed that the base station 200 is an NR node and the base station 300 is eNB.

The user equipment 100 is any appropriate information processing device with a wireless communication function, such as a smart phone, a mobile phone, a tablet computer, a wearable terminal, or an IoT terminal, and can communicate with both an LTE system and the wireless communication system (NR system) according to this embodiment. The user equipment 100 operates in three communication states, that is, a connected state (RRC_CONNECTED state), an inactive state (RRC_INACTIVE state), and an idle state (RRC_IDLE state) in wireless communication with the base station 200 and operates in two communication states, that is, the connected state (RRC_CONNECTED state) and the idle state (RRC_IDLE state) in wireless communication with the base station 300. In addition, “NR” may be added to a state name in the NR system and “LTE” (or “E-UTRA”) may be added to a state name in the LTE system. In the specification, “NR” and “LTE” (or “E-UTRA”) are not added when the state of the system is clear and when the systems do not need to be distinguished from each other.

The connected state (RRC_CONNECTED state) in the NR system corresponds to the RRC_CONNECTED state in the LTE system. The base station 200 controls the mobility of the user equipment 100 and allocates an individual radio resource (hereinafter, referred to as an individual resource) to the user equipment 100.

The idle state (RRC_IDLE state) in the NR system corresponds to the RRC_IDLE state in the LTE system. The user equipment 100 controls its own mobility and paging based on the core network (CN) is performed. In the idle state, the individual resource is not allocated and an AS context indicating radio parameters configured between the user equipment 100 and the base station 200 in the connected state is discarded in the user equipment 100 and the base station 200.

(For Method Associated with Intermediate State)

As described above, the wireless communication system according to this embodiment supports the intermediate state between the connected state and the idle state and operations in Examples 1 to 3 which will be described below are basically performed in the intermediate state. First, the method (function) of the wireless communication system related to the intermediate state will be described.

As described above, the inactive state (RRC_INACTIVE state) in the NR system corresponds to the intermediate state between the RRC_CONNECTED state and the RRC_IDLE state in the LTE system. That is, in the RRC_INACTIVE state, the user equipment 100 controls its own mobility and can autonomously perform, for example, cell reselection. The individual resource is not allocated to the user equipment 100. The connection related to the user equipment 100 is maintained between the core network and the base station 200 and paging based on a radio access network (RAN) or the base station is performed. That is, downlink data is transmitted from the core network to the base station 200 (network monitor mode (NMM) registered ready state) and paging is performed for a base-station-based position registration area which will be described. In addition, an AS context indicating radio parameters for wireless communication between the user equipment 100 and the base station 200 is retained in the user equipment 100 and the base station 200. Therefore, when the state returns to the connected state, the user equipment 100 can rapidly resume wireless communication with the base station 200 according to the radio parameters. The intermediate state between the connected state and the idle state is not limited to the above-mentioned INACTIVE state and may be other states having both the characteristics of the connected state and the characteristics of the idle state. Other states may also be referred to as the “intermediate state”.

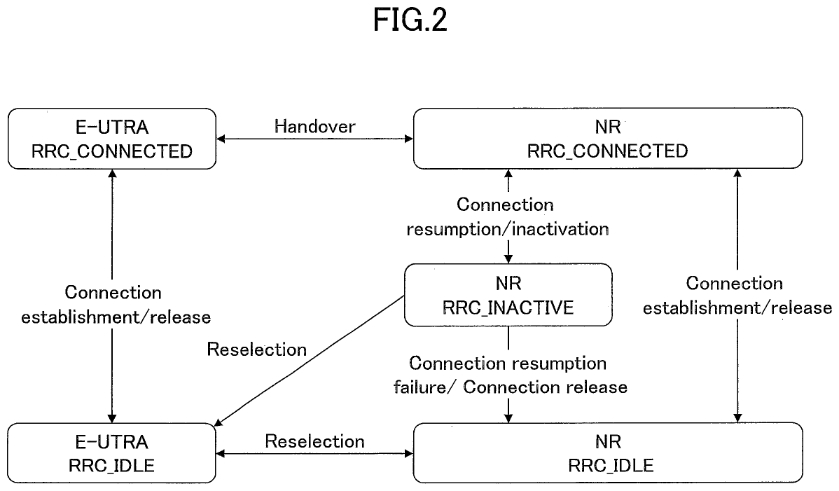

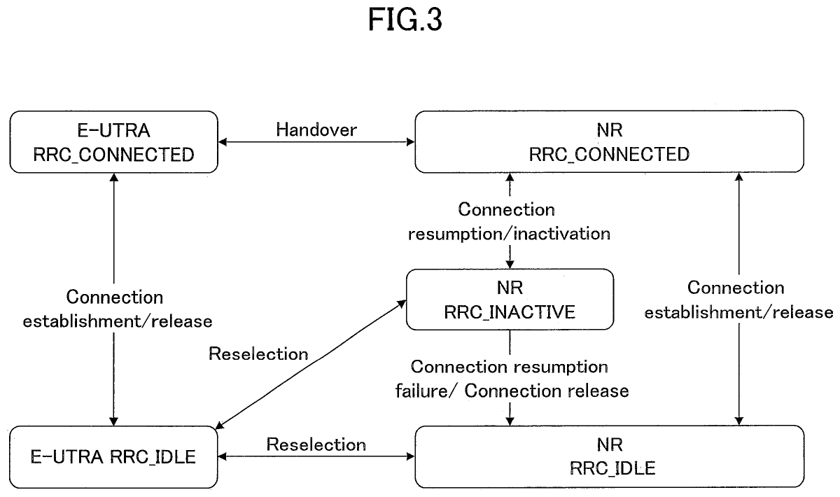

FIG. 2 is a diagram illustrating example 1 of RRC state transition and FIG. 3 is a diagram illustrating example 2 of RRC state transition. As can be seen from FIGS. 2 and 3, example 1 and example 2 are different from each other only in transition between the RRC_INACTIVE state and an E-UTRA (LTE) RRC_IDLE state. That is, in example 1, the user equipment 100 can change from the RRC_INACTIVE state to the E-UTRA RRC_IDLE state. However, the user equipment 100 is not capable of changing from the E-UTRA RRC_IDLE state to the RRC_INACTIVE state and can change in only one direction from the RRC_INACTIVE state to the E-UTRA RRC_IDLE state. In contrast, in example 2, the user equipment 100 can change from the RRC_INACTIVE state to the E-UTRA RRC_IDLE state, can change from the E-UTRA RRC_IDLE state to the RRC_INACTIVE state, and can bidirectionally change between the RRC_INACTIVE state and the E-UTRA RRC_IDLE state. The reason is as follows. In example 1, the user equipment 100 changes from the RRC_INACTIVE state to the E-UTRA RRC_IDLE state and then discards the AS context for wireless communication with the base station 200 which is a transition source. In contrast, in example 2, the user equipment 100 changes from the RRC_INACTIVE state to the E-UTRA RRC_IDLE state and then retains the AS context for wireless communication with the base station 200 which is a transition source.

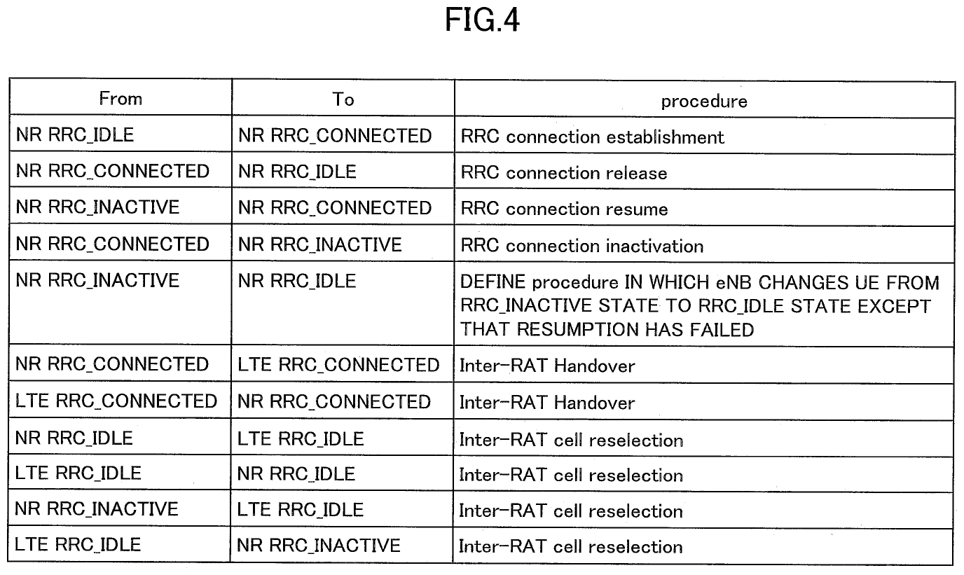

FIGS. 2 and 3 illustrate detailed procedures used for transition between communication states. FIG. 4 illustrates a list of the procedures. In the following description, transition processes related to an NR RRC_INACTIVE state, that is, a transition process from an NR RRC_CONNECTED state to an NR RRC_INACTIVE state, a transition process from the NR RRC_INACTIVE state to an NR RRC_IDLE state, a transition process from the NR RRC_INACTIVE state to an LTE RRC_IDLE state, and a transition process from the LTE RRC_IDLE state to the NR RRC_INACTIVE state will be described. Among these transition processes, the transition process from the NR RRC_CONNECTED state to the NR RRC_INACTIVE state and the transition process from the NR RRC_INACTIVE state to the NR RRC_IDLE state are achieved in the NR system. The transition process from the NR RRC_INACTIVE state to the LTE RRC_IDLE state and the transition process from the LTE RRC_IDLE state to the NR RRC_INACTIVE state are achieved as inter-RAT cell reselection between the NR system and the LTE system.

It is considered that the transition process from the NR RRC_INACTIVE state to the NR RRC_CONNECTED state can be achieved by the application of RRC connection resume in the LTE system. In the following description, the detailed description of the transition process is omitted.

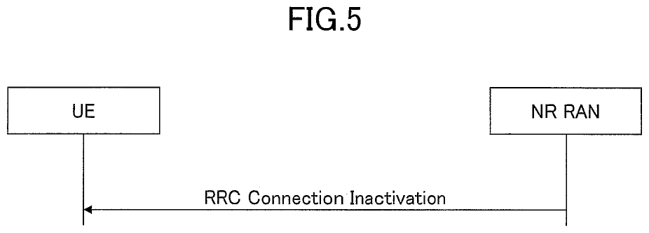

Next, the transition process from the RRC_CONNECTED state to the RRC_INACTIVE state will be described with reference to FIGS. 5 to 7. FIG. 5 is a diagram illustrating a state transition procedure from the RRC_CONNECTED state to the RRC_INACTIVE state.

As illustrated in FIG. 5, the user equipment 100 receives an inactivation message (RRC Connection Inactivation (which may also be referred to as RRC Connection Sustenance)) for transition from the connected state to the inactive state from the base station 200. When receiving the message, the user equipment 100 changes from the connected state to the inactive state, extracts, from the inactivation message, a context identifier for specifying radio parameter information for wireless communication between the user equipment 100 and the base station 200 and a base-station-based position registration area having one or more cells including the cell of the base station 200, and retains the radio parameter information, the context identifier, and the base-station-based position registration area.

Specifically, the inactivation message may include a resume ID for specifying an AS context indicating the radio parameters configured in the user equipment 100 when the user equipment 100 is connected to the base station 200 and a base-station-based position registration area indicating a plurality of cells that transmit a paging channel to the user equipment 100 in the inactive state. When the inactivation message is transmitted, the base station 200 retains the AS context and the resume ID of the user equipment 100. Here, the resume ID is an identifier for uniquely specifying the AS context configured in the user equipment 100 in the NR system. However, the context identifier according to this embodiment is not limited thereto and may be any other appropriate identifiers that are configured in the user equipment 100 and can specify the retained radio parameter information. In addition, typically, the base-station-based position registration area may be smaller than a core-network-based position registration area indicating a base station to which the core network managing the base station 200 transmits a paging channel.

The inactivation message may further include timer information indicating the effective period of the radio parameter information and the base-station-based position registration area. Specifically, the user equipment 100 configures an individual or common timer in the retained AS context and/or base-station-based position registration area on the basis of the timer information and measures the retention time of the AS context and/or the base-station-based position registration area. When the timer expires, the user equipment 100 may discard the AS context and/or perform a base-station-based position registration area update procedure which will be described below.

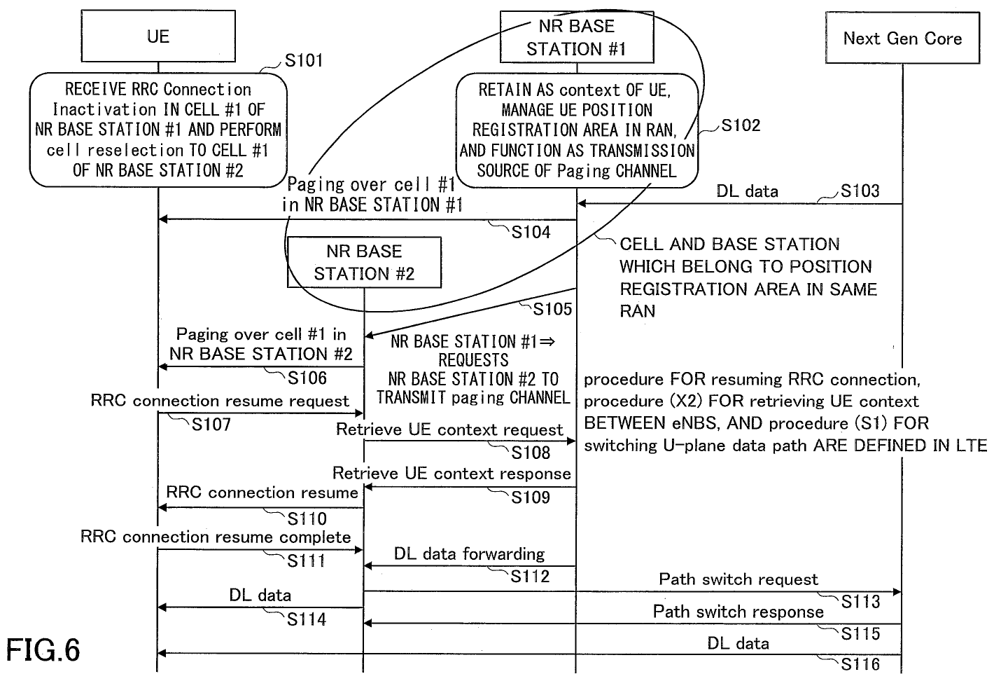

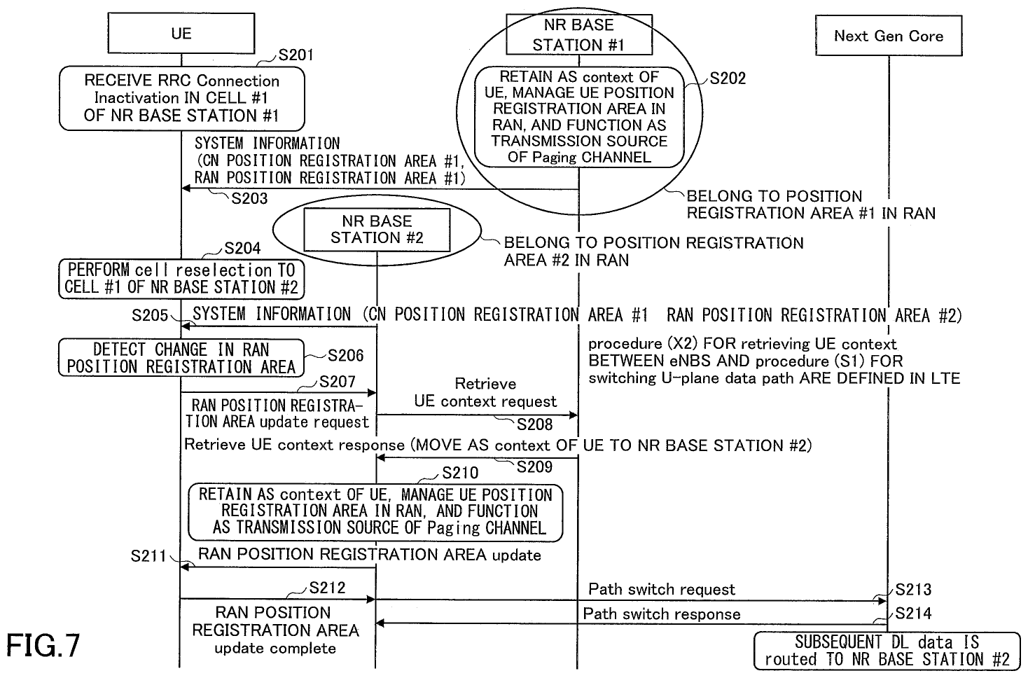

As described above, in the inactive state, the connection between the core network and the base station 200 with respect to the user equipment 100 is maintained. Therefore, downlink data addressed from the core network to the user equipment 100 is transmitted to the base station 200. A receiving procedure for the user equipment 100 in an inactive state will be described with reference to FIGS. 6 and 7. In the example illustrated in FIGS. 6 and 7, the user equipment 100 which has received an inactivation message from the base station 200 (NR base station #1) and has changed to an inactive state performs cell reselection to another base station (NR base station #2) in the NR system.

FIG. 6 is a sequence diagram illustrating a receiving process in the RRC_INACTIVE state. In the example illustrated in FIG. 6, it is assumed that NR base station #1 and NR base station #2 belong to the same base-station-based (in-RAN) position registration area. In addition, the user equipment 100 is represented by “UE”.

As illustrated in FIG. 6, in Step S101, the user equipment 100 receives an inactivation message (RRC Connection Inactivation) from NR base station #1, changes to the RRC_INACTIVE state, and performs cell reselection to NR base station #2.

In Step S102, after transmitting the inactivation message, NR base station #1 retains an AS context, a resume ID, and a base-station-based position registration area for the user equipment 100 and functions as the transmission source of a paging channel to the user equipment 100.

In Step S103, NR base station #1 receives downlink data addressed to the user equipment 100 from the core network.

In Step S104, NR base station #1 transmits a paging channel (which may also be referred to as a paging signal) in the cell of NR base station #1 in order to notify that the downlink data addressed to the user equipment 100 has been received. In Step S105, NR base station #1 instructs all of the base stations in the base-station-based position registration area to transmit a paging channel for notifying that the downlink data addressed to the user equipment 100 has been received. At the transmission time of the paging channel, the user equipment 100 camps on NR base station #2 in the base-station-based position registration area. Therefore, in Step S106, the user equipment 100 receives a paging channel from NR base station #2.

In Step S107, the user equipment 100 in the idle state transmits an RRC connection resume request including the retained resume ID to NR base station #2, in order to establish a communication connection with NR base station #2 for the reception of downlink data transmitted from the core network. That is, the communication connection can be established by using the AS context retained in the user equipment 100 and the NR base station #1 in the inactive state. Therefore, the communication connection is not established by RRC connection establishment, but can be established by RRC connection resume. The order of steps in the following communication resumption process is just an example and is not limited to the following.

In Step S108, NR base station #2 transmits Retrieve UE context request including the resume ID to NR base station #1 in order to acquire the AS context of the user equipment 100. In Step S109, NR base station #2 receives the requested AS context through Retrieve UE context response.

In Step S110, NR base station #2 transmits RRC connection resume to the user equipment 100 in order to resume the radio connection with the user equipment 100 on the basis of the acquired AS context. In Step S111, NR base station #2 receives RRC connection resume complete indicating the completion of the resumption of the radio connection.

In Step S112, NR base station #2 receives downlink data addressed to the user equipment 100 from NR base station #1.

In Step S113, NR base station #2 transmits Path switch request to the core network (which is represented by Next Generation (Gen) Core in FIG. 6) such that the transmission destination of the downlink data addressed to the user equipment 100 is changed from NR base station #1 to NR base station #2.

In Step S114, NR base station #2 transmits the downlink data transmitted from NR base station #1 to the user equipment 100.

In Step S115, NR base station #2 receives Path switch response indicating that the transmission destination of the downlink data addressed to the user equipment 100 has been changed.

In Step S116, NR base station #2 transmits the downlink data addressed to the user equipment 100, which has been transmitted from the core network, to the user equipment 100.

FIG. 7 is a diagram showing another example of the sequence indicating the receiving process in the RRC_INACTIVE state. In the example illustrated in FIG. 7, it is assumed that NR base station #1 and NR base station #2 belong to different base-station-based (in-RAN) position registration areas.

As illustrated in FIG. 7, in Step S201, the user equipment 100 receives an inactivation message (RRC Connection Inactivation) from NR base station #1 and changes to an RRC_INACTIVE state.

In Step S202, after transmitting the inactivation message, NR base station #1 retains an AS context, a resume ID, and a base-station-based position registration area for the user equipment 100 and functions as the transmission source of a paging channel to the user equipment 100.

In Step S203, the user equipment 100 receives system information broadcasted in the cell on which NR base station #1 camps. Specifically, the system information includes a core-network-based position registration area (a tracking area in the LTE system) and a base-station-based position registration area indicating the base station that transmits a paging channel to the user equipment 100 in the inactive state.

In Step S204, the user equipment 100 performs cell reselection to NR base station #2.

In Step S205, the user equipment 100 receives the system information broadcasted in the cell on which NR base station #2 camps. Specifically, the system information includes a core-network-based position registration area (a tracking area in the LTE system) and a base-station-based position registration area indicating the base station that transmits a paging channel to the user equipment 100 in the inactive state. In the example illustrated in FIG. 7, NR base station #1 and NR base station #2 belong to different base-station-based position registration areas.

In Step S206, the user equipment 100 detects that the base-station-based position registration area received in Step S203 is different from the base-station-based position registration area received in Step S206 and determines that the base-station-based position registration area has been changed. In this case, even when NR base station #1 receives the downlink data addressed to the user equipment 100 from the core network, NR base station #1 is not capable of notifying the user equipment 100 of the reception of the downlink data, using the paging channel. Therefore, in the following step, it is necessary to perform a process of changing the base-station-based position registration area.

In Step S207, the user equipment 100 transmits an update request including the retained resume ID to NR base station #2, in order to update the base-station-based position registration area of the user equipment 100 with the base-station-based position registration area of NR base station #2.

In Step S208, NR base station #2 transmits Retrieve UE context request including the resume ID to NR base station #1 in order to acquire the AS context of the user equipment 100. In Step S209, NR base station #2 receives the requested AS context through Retrieve UE context response.

In Step S210, NR base station #2 retains the AS context, the resume ID, and the base-station-based position registration area for the user equipment 100 and functions as the transmission source of a paging channel to the user equipment 100.

In Step S211, NR base station #2 instructs the user equipment 100 to update the base-station-based position registration area. In Step S212, NR base station #2 receives a notice indicating the completion of the update of the base-station-based position registration area.

In Step S213, NR base station #2 transmits Path switch request to the core network such that the transmission destination of the downlink data addressed to the user equipment 100 is changed from NR base station #1 to NR base station #2. In Step S214, NR base station #2 receives Path switch response indicating that the transmission destination of the downlink data addressed to the user equipment 100 has been changed. Then, the downlink data addressed to the user equipment 100 is transmitted from the core network to NR base station #2.

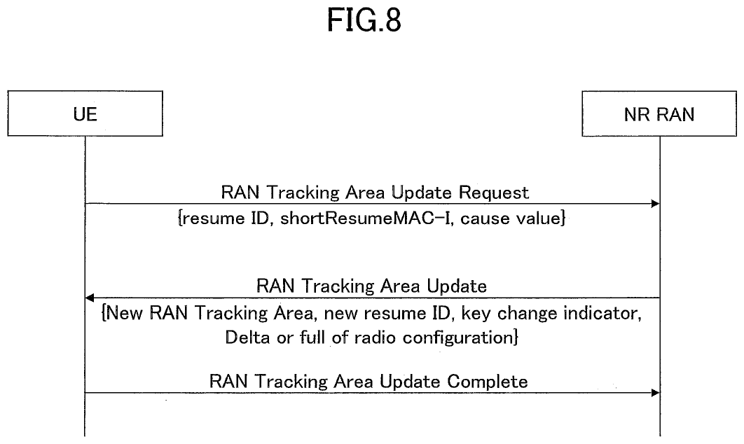

Next, a procedure for updating the base-station-based position registration area will be described in detail with reference to FIG. 8. As described above, for example, the update procedure is performed in response to the detection of the difference between the retained base-station-based position registration area and the base-station-based position registration area acquired after cell reselection.

As illustrated in FIG. 8, the user equipment 100 transmits RAN Tracking Area Update Request to the NR base station (for example, the base station 200) (NR base station #2 in the above-mentioned example) in order to request the update of the base-station-based position registration area. For example, the RAN Tracking Area Update Request may include an identifier (for example, shortResumeMAC-I) for authenticating the AS context and a cause value indicating the cause of the position registration update, in addition to the resume ID for specifying the retained AS context.

When receiving RAN Tracking Area Update Request, the NR base station transmits RAN Tracking Area update to user equipment 100. For example, RAN Tracking Area update may include a new base-station-based position registration area (New RAN Tracking Area), a new resume ID, security update instruction (key change indicator) (if necessary), and radio configuration (when an update is performed). Since the base station retaining the AS context of the user equipment 100 is changed, a new resume ID is notified to the user equipment 100. For security key update, Refresh and/or Re-keying may be used, as in the LTE standard. In addition, when the radio configuration (including a bearer) is updated, all of the updated radio configurations may be notified or only the difference therebetween may be notified.

Then, the user equipment 100 transmits RAN Tracking Area Update Complete to the NR base station.

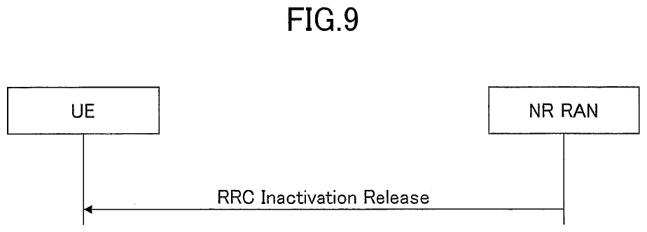

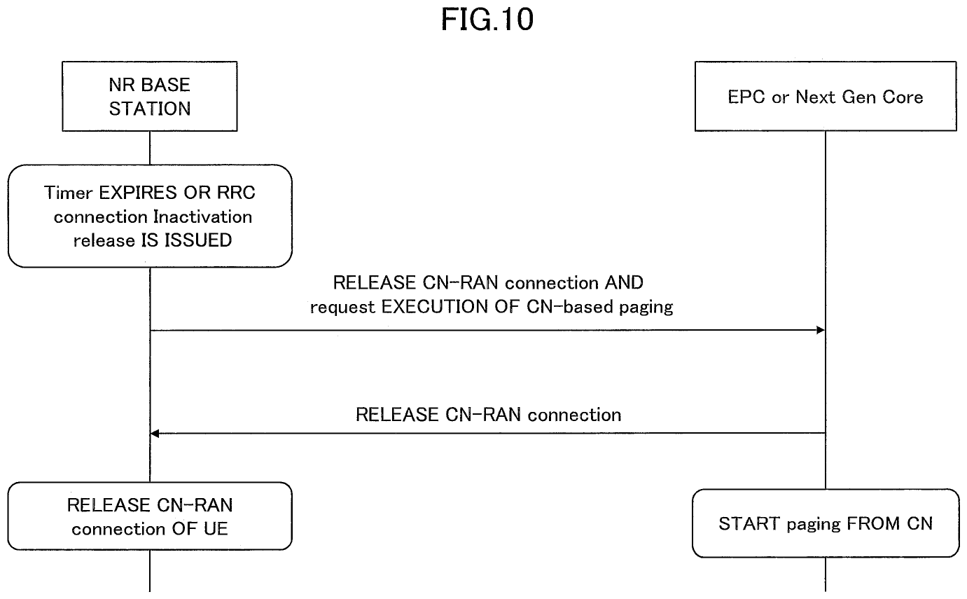

Next, a transition process from the RRC_INACTIVE state to the NR RRC_IDLE state will be described with reference to FIGS. 9 and 10. FIG. 9 is a diagram illustrating a state transition procedure from the RRC_INACTIVE state to the NR RRC_IDLE state. In the example illustrated in FIG. 9, the user equipment 100 is changed from the inactive state to the idle state by signaling from the base station 200.

As illustrated in FIG. 9, the user equipment 100 receives a release message (RRC Inactivation Release (RRC Sustenance Release)) for transition from the inactive state to the idle state from the base station 200. When receiving the release message, the user equipment 100 determines whether the release message is addressed to the user equipment 100 on the basis of the retained context identifier. When determining that the release message is addressed to the user equipment 100, the user equipment 100 changes from the inactive state to the idle state. The release message may be achieved in a new procedure such as RRC Inactivation Release which is newly defined, as illustrated in FIG. 9, or a procedure in the LTE system, such as RRC connection release or a paging message, may be used.

As described above, in the inactive state, an individual resource is not allocated to the user equipment 100 and the base station 200 transmits the release message to the user equipment 100 using a common channel (common control channel). Alternatively, the release message may be notified by a logical channel or a message which can be received by only the user equipment 100 in the inactive state. For example, the release message may be notified by a newly defined logical channel, such as a sustained control channel (SCCH), or may be mapped like SCCH (logical channel)-DL-SCH (transport channel)-PDSCH (physical channel). Alternatively, a radio network temporary ID (RNTI) for an inactive state may be defined and the cyclic redundancy check (CRC) of the message may be scrambled into RNTI.

The release message may include the resume ID. In this case, when the user equipment 100 in the inactive state receives the release message, the user equipment 100 determines whether the received resume ID is identical to the retained resume ID. When the resume IDs are identical to each other, the retained corresponding AS context and base-station-based position registration area are discarded and the user equipment 100 is changed from the inactive state to the idle state.

In the above-mentioned example, the user equipment 100 is changed from the inactive state to the idle state by signaling from the base station 200. As another example, a timer that measures the retention period of the radio parameter information, the context identifier, and the base-station-based position registration area may be used. When the timer expires, the user equipment 100 may autonomously change from the inactive state to the idle state. Specifically, the user equipment 100 configures an individual or common timer for the retained AS context, the resume ID, and/or the base-station-based position registration area and measures the retention time of the AS context, the resume ID, and/or the base-station-based position registration area. When the timer expires, the user equipment 100 may discard the AS context, the resume ID, and/or the base-station-based position registration area and autonomously change from the RRC_INACTIVE state to the NR RRC_IDLE state. In this case, when the user equipment 100 changes from the RRC_CONNECTED state to the RRC_INACTIVE state, the individual or common timer may be notified from the base station 200 to the user equipment 100. Alternatively, the individual or common timer may be notified through an inactivation message (RRC Connection Inactivation) from the base station 200.

In this way, when the user equipment 100 is changed from the inactive state to the idle state by the release message from the base station 200 or when the user equipment 100 autonomously changes from the inactive state to the idle state using the timer, the connection between the base station 200 and the core network may also be released. Specifically, the connection between the base station 200 and the core network may be released according to a release procedure illustrated in FIG. 10.

That is, when the timer configured in the user equipment 100 expires or after RRC Inactivation (Sustenance) Release is transmitted to the user equipment 100, the base station 200 releases the connection maintained between the core network and the base station 200. When the downlink data addressed to the user equipment 100 is received, the base station 200 requests the core network to perform paging for the base station in the core-network-based position registration area. The core-network-based position registration area corresponds to a tracking area in the LTE system and indicates the base station that is notified of paging by the core network. In this way, the connection maintained between the base station 200 and the core network is released. Then, when the downlink data addressed to the user equipment 100 is received, the core network does not transmit the downlink data to the base station 200 and notifies the base station in the core-network-based position registration area of paging.

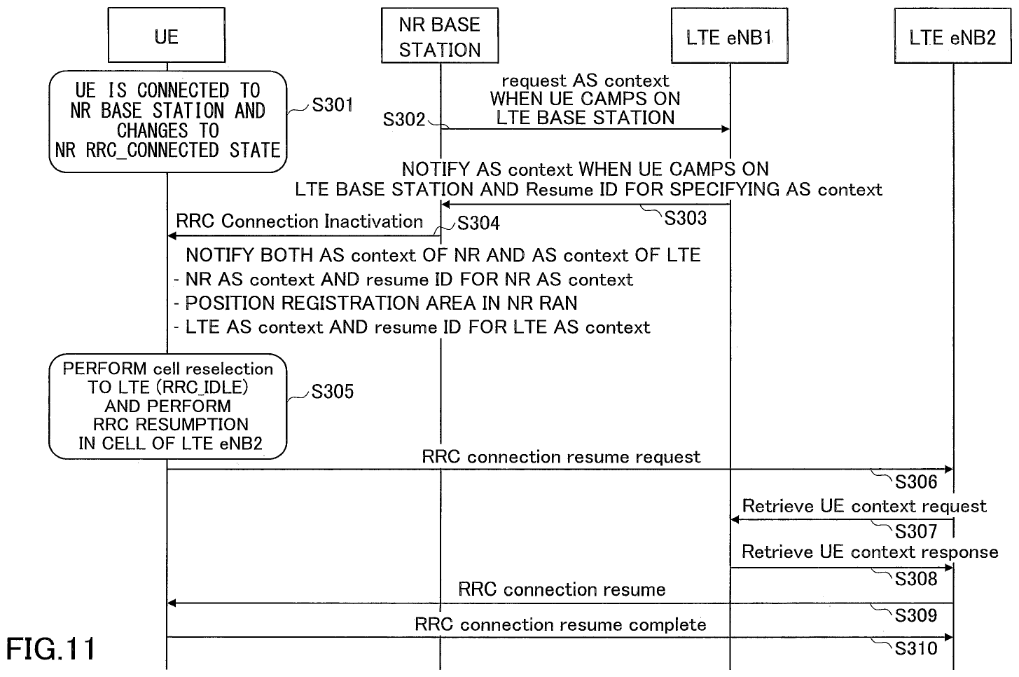

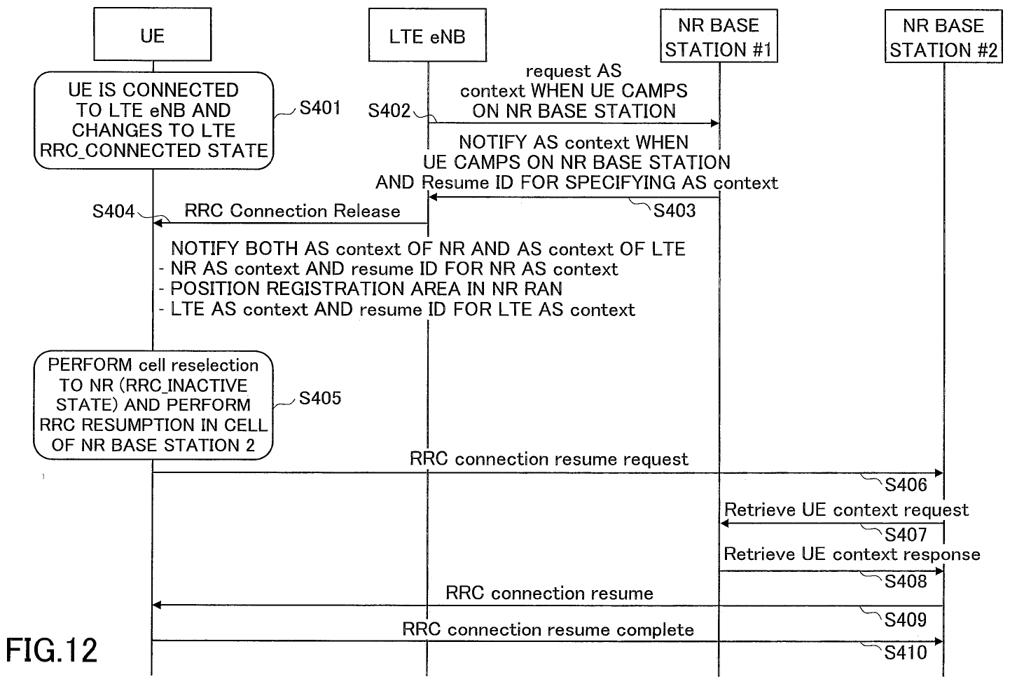

Next, a transition process between the RRC_INACTIVE state and the LTE RRC_IDLE state will be described with reference to FIGS. 11 and 12. As described above, the user equipment 100 in the inactive state can autonomously perform cell reselection (inter-RAT cell reselection) to the base station 300 in the LTE system in order to control the mobility of the user equipment 100.

As described with reference to FIGS. 2 and 3, for the transition process between the RRC_INACTIVE state and the LTE RRC_IDLE state, the following transition procedure examples are assumed: transition procedure example 1 in which an AS context is discarded in transition between RATS and transition can be performed in only one direction from the RRC_INACTIVE state to the LTE RRC_IDLE state; and transition procedure example 2 in which an AS context is retained in transition between RATS and transition can be bidirectionally performed between the RRC_INACTIVE state and the LTE RRC_IDLE state.

First, the transition process from the RRC_INACTIVE state to the LTE RRC_IDLE state according to transition procedure example 1 will be described. In this example, in a case in which the user equipment 100 communicates with the base station 200 in the inactive state (RRC_INACTIVE), when performing cell reselection to the base station 300, the user equipment 100 may change from the inactive state to the idle state (LTE RRC_IDLE) in the base station 300 and may discard the radio parameter information, the context identifier, and the base-station-based position registration area at a predetermined discard time.

Specifically, when the user equipment 100 in the RRC_INACTIVE state performs cell reselection to the base station 300 in the LTE system and camps on the cell of the base station 300, the user equipment 100 changes from the RRC_INACTIVE state to the LTE RRC_IDLE state. In transition procedure example 1, the AS context is discarded in the transition between RATS. Therefore, the user equipment 100 discards the retained AS context, resume ID, and base-station-based position registration area at a predetermined discard time. The user equipment 100 may discard the retained AS context, resume ID, and/or base-station-based position registration area at the time when cell reselection to the base station 300 is performed.

As another example, the user equipment 100 configures an individual or common timer for the retained AS context, resume ID, and/or base-station-based position registration area and measures the retention time of the AS context, the resume ID, and/or the base-station-based position registration area. When the timer expires (without depending on whether the user equipment 100 camps on the base station 200 or the base station 300), the user equipment 100 may discard the AS context, the resume ID, and/or the base-station-based position registration area.

As still another example, the user equipment 100 may discard the AS context, the resume ID, and/or the base-station-based position registration area at the time when a communication connection is established with the base station 300 on which the user equipment 100 camps after cell reselection or at the time when the establishment of the communication connection is completed. That is, when the user equipment 100 performs cell reselection to the base station 300 (LTE RRC_IDLE), the user equipment 100 may retain the AS context, the resume ID, and/or the base-station-based position registration area. When the user equipment 100 changes to a connected state in the base station 300 (LTE RRC_CONNECTED), the user equipment 100 may discard the AS context, the resume ID, and/or the base-station-based position registration area.

Next, the transition process from the RRC_INACTIVE state to the LTE RRC_IDLE state according to transition procedure example 2 will be described. In this example, in a case in which the user equipment 100 communicates with the base station 200 in the inactive state, when performing cell reselection to the base station 300, the user equipment 100 performs cell reselection to the base station 300 while retaining radio parameter information for wireless communication between the user equipment 100 and the base station 200 and a context identifier for specifying the radio parameter information. Specifically, in a case in which the user equipment 100 communicates with the base station 200 in the RRC_INACTIVE state, when performing cell reselection to the base station 300, the user equipment 100 changes from the RRC_INACTIVE state to the LTE RRC_IDLE state, without discarding the AS context, the resume ID, and the base-station-based position registration area.

FIG. 11 is a diagram illustrating the state transition process from the RRC_INACTIVE state to the LTE RRC_IDLE state according to transition procedure example 2.

As illustrated in FIG. 11, in Step S301, the user equipment 100 is connected to the base station 200 (NR base station). The user equipment 100 manages the communication state of the user equipment 100 as NR RRC_CONNECTED.

In Step S302, the NR base station requests the base station 300 (LTE eNB#1) in the LTE system to transmit the AS context applied when the user equipment 100 is connected to LTE eNB#1.

In Step S303, the NR base station acquires the AS context configured in the user equipment 100 in wireless communication with LTE eNB#1 and the resume ID for specifying the AS context. That is, when the user equipment 100 is connected to the NR base station, the NR base station acquires radio parameter information for wireless communication between the user equipment 100 and LTE eNB#1 and a context identifier from LTE eNB#1.

In Step S304, the NR base station transmits an inactivation message (RRC Connection Inactivation (Sustenance)) for changing the user equipment 100 from the NR RRC_CONNECTED state to the RRC_INACTIVE state to the user equipment 100. The inactivation message may include an AS context and a resume ID which are configured in the user equipment 100 for wireless communication with the NR base station, an AS context and a resume ID which are configured in the user equipment 100 for wireless communication with LTE eNB#1, and a base-station-based position registration area. When receiving the inactivation message, the user equipment 100 changes from the NR RRC_CONNECTED state to the NR RRC_INACTIVE state. In addition, the user equipment 100 retains the AS context and the resume ID configured in the user equipment 100 for wireless communication with the NR base station, the AS context and the resume ID configured in the user equipment 100 for wireless communication with LTE eNB#1, and the base-station-based position registration area. That is, when receiving the inactivation message for changing the user equipment 100 from the connected state to the inactivation state from the NR base station, the user equipment 100 extracts radio parameter information for wireless communication between the user equipment 100 and the NR base station, a context identifier for specifying the radio parameter information, radio parameter information for wireless communication between the user equipment 100 and LTE eNB#1, a context identifier for specifying the radio parameter information, and a base-station-based position registration area of the NR base station from the inactivation message and retains the extracted data.

In Step S305, the user equipment 100 performs cell reselection to LTE eNB#2, determines to establish a radio connection with LTE eNB#2, and performs the subsequent steps for establishing a radio connection with LTE eNB#2.

In Step S306, the user equipment 100 transmits an RRC connection resume request including the retained resume ID to LTE eNB#2 in order to establish a radio connection.

In Step S307, LTE eNB#2 transmits Retrieve UE context request including the resume ID to LTE eNB#1 in order to acquire the AS context of the user equipment 100. In Step S308, LTE eNB#2 receives the requested AS context through Retrieve UE context response. The resume ID is configured so as to indicate LTE eNB#1 in which the corresponding AS context is retained. Therefore, LTE eNB#2 can determine that the AS context corresponding to the received resume ID is retained in LTE eNB#1.

In Step S309, LTE eNB#2 transmits RRC connection resume to the user equipment 100 in order to resume the radio connection with the user equipment 100 on the basis of the acquired AS context. In Step S310, LTE eNB#2 receives RRC connection resume complete indicating the completion of the resumption of the radio connection. In this way, the radio connection between the user equipment 100 and LTE eNB#2 is established.

Next, the transition process from the LTE RRC_IDLE state to the RRC_INACTIVE state according to transition procedure example 2 will be described. In this example, in a case in which the user equipment 100 in the idle state communicates with the base station 300, when performing cell reselection to the base station 200, the user equipment 100 performs cell reselection to the base station 200 while retaining radio parameter information for wireless communication between the user equipment 100 and the base station 300 and a context identifier for specifying the radio parameter information. Specifically, when the user equipment 100 in the LTE RRC_IDLE state camps on the base station 300 and performs cell reselection to the base station 200, the user equipment 100 changes from the LTE RRC_IDLE state to the RRC_INACTIVE state, without discarding the AS context, the resume ID, and the base-station-based position registration area.

FIG. 12 is a diagram illustrating the state transition procedure from the LTE RRC_IDLE state to the RRC_INACTIVE state according to transition procedure example 2.

As illustrated in FIG. 12, in Step S401, the user equipment 100 is connected to the base station 300 (LTE eNB) and manages the communication state of the user equipment 100 as RRC_CONNECTED.

In Step S402, LTE eNB requests the base station 200 (NR base station #1) in the NR system to transmit the AS context applied when the user equipment 100 is connected to NR base station #1.

In Step S403, LTE eNB acquires the AS context configured in the user equipment 100 in wireless communication with NR base station #1 and the resume ID for specifying the AS context. That is, when the user equipment 100 is connected to LTE eNB, LTE eNB acquires radio parameter information for wireless communication between the user equipment 100 and NR base station #1 and a context identifier from NR base station #1.

In Step S404, LTE eNB transmits a release message (RRC Connection Release) for changing the user equipment 100 from the LTE RRC_CONNECTED state to the LTE RRC_IDLE state to the user equipment 100. The release message may include an AS context and a resume ID which are configured in the user equipment 100 for wireless communication with LTE eNB, an AS context and a resume ID which are configured in the user equipment 100 for wireless communication with NR base station #1, and a base-station-based position registration area. When receiving the message, the user equipment 100 changes from the LTE RRC_CONNECTED state to the LTE RRC_IDLE state. In addition, the user equipment 100 retains the AS context and the resume ID configured in the user equipment 100 for wireless communication with LTE eNB, the AS context and the resume ID configured in the user equipment 100 for wireless communication with NR base station #1, and the base-station-based position registration area. That is, when receiving a release message for changing the user equipment 100 from the connected state to the idle state from LTE eNB, the user equipment 100 extracts radio parameter information for wireless communication between the user equipment 100 and LTE eNB, a context identifier for specifying the radio parameter information, radio parameter information for wireless communication between the user equipment 100 and NR base station #1, a context identifier for specifying the radio parameter information, and a base-station-based position registration area of NR base station #1 from the release message and retains the extracted data.

In Step S405, the user equipment 100 performs cell reselection to NR base station #2, determines to establish a radio connection with NR base station #2, and performs the subsequent steps for establishing a radio connection with NR base station #2.

In Step S406, the user equipment 100 transmits an RRC connection resume request including the retained resume ID to NR base station #2 in order to establish a radio connection.

In Step S407, NR base station #2 transmits Retrieve UE context request including the resume ID to NR base station #1 in order to acquire the AS context of the user equipment 100. In Step S408, NR base station #2 receives the requested AS context through Retrieve UE context response. The resume ID is configured so as to indicate NR base station #1 in which the corresponding AS context is retained. Therefore, NR base station #2 can determine that the AS context corresponding to the received resume ID is retained in NR base station #1.

In Step S409, NR base station #2 transmits RRC connection resume to the user equipment 100 in order to resume the radio connection with the user equipment 100 on the basis of the acquired AS context. In Step S410, NR base station #2 receives RRC connection resume complete indicating the completion of the resumption of the radio connection. In this way, the radio connection between the user equipment 100 and NR base station #2 is established.

As described above, according to transition procedure example 2, the user equipment 100 continuously retains radio parameter information (AS context) for the LTE system and the NR system and a context identifier (resume ID) for specifying the AS context during cell reselection. The user equipment 100 includes a timer for measuring the retention period of one or both of the radio parameter information and the context identifier of the base stations 200 and 300. When the timer expires, the user equipment 100 may discard one or both of the retained radio parameter information and the retained context identifier. As another example, when the user equipment 10 performs cell reselection to another RAT (for example, Universal Mobile Telecommunications System (UMTS) or Global System for Mobile communications (GSM) (registered trademark)) system other than the LTE system and the NR system, the user equipment 100 may discard the AS context, the resume ID, and/or the base-station-based position registration area. As still another example, even after the user equipment 100 performs cell reselection to another RAT system, the user equipment 100 may continuously retain the AS context, the resume ID, and/or the base-station-based position registration area until the timer expires. As yet another example, the user equipment 100 may discard the AS context, the resume ID, and/or the base-station-based position registration area at the time when it performs cell reselection to another RAT system and then establishes a communication connection with the RAT base station on which the user equipment 100 camps or at the time when the establishment of the communication connection is completed. That is, when the user equipment 100 performs cell reselection to another RAT system, the user equipment 100 may continuously retain the AS context, the resume ID, and/or the base-station-based position registration area. After the user equipment 100 changes to a connected state in another RAT base station, the user equipment 100 may discard the AS context, the resume ID, and/or the base-station-based position registration area.

(Entire Processing Operation in Embodiment of the Invention)

Next, an example of the processing operation of the user equipment 100 in the RRC_INACTIVE state (RRC_SUSTAINED state) when UL data is generated will be described as the processing operation in the embodiment of the invention. In the RRC_INACTIVE state (SUSTAINED state), the user equipment 100 does not retain the individual resource and does not perform CQI feedback to the base station 200. Therefore, a modulation and coding scheme (MCS) uses a robust configuration such that the user equipment 100 can transmit UL data even in a state in which the user equipment 100 is located at the end of a cell. In this case, it is difficult to increase the amount of UL data that can be transmitted.

For this reason, in this embodiment, basically, when the size of UL data generated (transmitted) in the user equipment 100 is small, the user equipment 100 in the RRC_INACTIVE state transmits UL data in a contention-based manner. In the contention-based transmission, an individual resource (a resource that does not contend with other user equipments) for UL data transmission is not allocated to the user equipment 100 and data is transmitted. In addition, the contention-based transmission may be considered as data transmission that is performed in a state (in this example, the RRC_INACTIVE state) other than the RRC_CONNECTED state.

On the other hand, when the size of UL data is large, it is difficult to perform the contention-based transmission. Therefore, the user equipment 100 changes to the RRC_CONNECTED state, receives the allocated individual resource, and performs contention-free UL data transmission in a state in which CQI feedback can be performed. In the contention-free transmission, an individual resource for UL data transmission is allocated to the user equipment 100 and data is transmitted. In addition, the contention-free transmission may be considered as data transmission that is performed in the RRC_CONNECTED state.

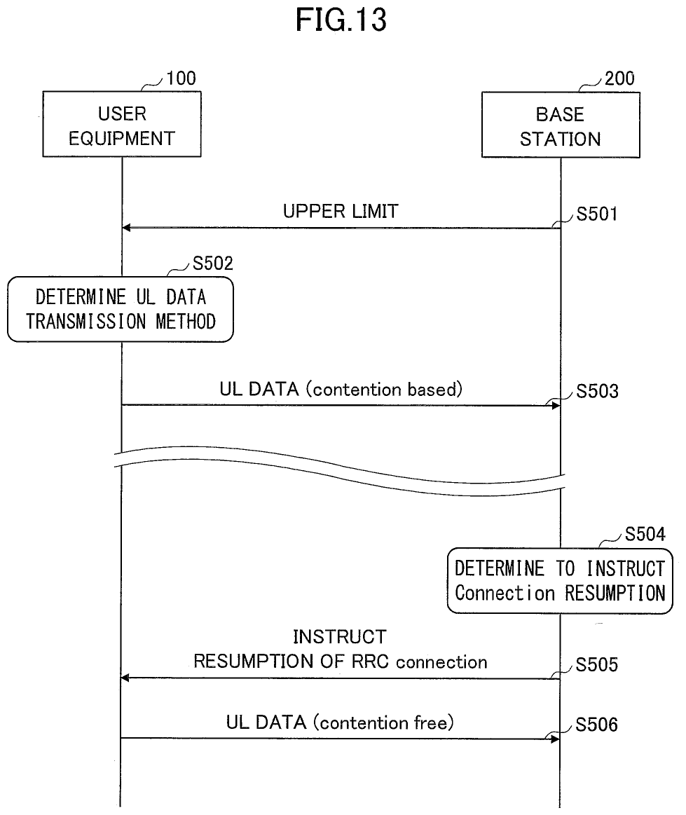

First, an example of the flow of the entire processing including the above-mentioned process will be described with reference to FIG. 13.

First, in Step S501, the base station 200 transmits the upper limit of the size of UL data, which can be transmitted in the contention-based manner by the user equipment 100 in the RRC_INACTIVE state, to the user equipment 100 and the upper limit is configured in the user equipment 100.

In Step S502, UL data is generated in the user equipment 100 and the user equipment 100 compares the upper limit configured in Step S501 with the size of the generated UL data to determine an UL data transmission method (contention-based or contention-free UL data transmission method).

In Step S503, the user equipment 100 transmits UL data (here, an example of the contention-based transmission is given). A technique for transmitting UL data in the RRC_CONNECTED state (that is, by contention free) has been known.

In some cases, the UL data that has been transmitted in the contention-based manner is not normally received by the base station 200. In this embodiment, when the base station 200 is not capable of receiving the UL data that has been transmitted in the contention-based manner, the base station 200 transmits Connection resume instruction (connection resumption instruction) to the user equipment 100 to change the user equipment 100 to the RRC_CONNECTED state and instructs the user equipment 100 to perform contention-free UL data transmission.

In the example illustrated in FIG. 13, in Step S504, the base station 200 determines to perform Connection resume instruction. In Step S505, the base station 200 transmits RRC connection resume instruction to the user equipment 100. In Step S506, the user equipment 100 performs contention-free UL data transmission.

Next, the operation in Steps S501 and S502 will be described in detail as Example 1, the operation in Step S503 will be described in detail as Example 2, and the operation in Steps S504 to S506 will be described in detail as Example 3.

### Example 1

First, Example 1 will be described in detail. As described above, in Example 1, when UL data is generated in the user equipment 100 in the RRC_INACTIVE state, the user equipment 100 compares the upper limit configured in Step S501 of FIG. 13 with the size of the UL data to determine whether to perform contention-based UL data transmission or contention-free UL data transmission.

The transmission of the upper limit from the base station 200 to the user equipment 100 in Step S501 of FIG. 13 is performed by a message (RRC connection inactivation message (which may also be referred to as an RRC connection sustenance message) for changing the user equipment 100 from the RRC_CONNECTED state to the RRC_INACTIVE state (the procedure illustrated in FIG. 5). That is, the message includes the upper limit. However, this is just an example and the upper limit may be transmitted from the base station 200 to the user equipment 100 by other messages (for example, a message used in the RRC_CONNECTED state).

The upper limit may be a value that is predetermined for each cell (each base station) or may be a value that is determined according to communication conditions (for example, the degree of congestion) and/or a communication environment (for example, a cell size). When the upper limit is determined according to the communication conditions (for example, the degree of congestion) and/or the communication environment (for example, a cell size), the base station 200 may determine the upper limit, an upper node or an operation system may determine the upper limit, or the upper node or the operation system may configure the upper limit in the base station 200.

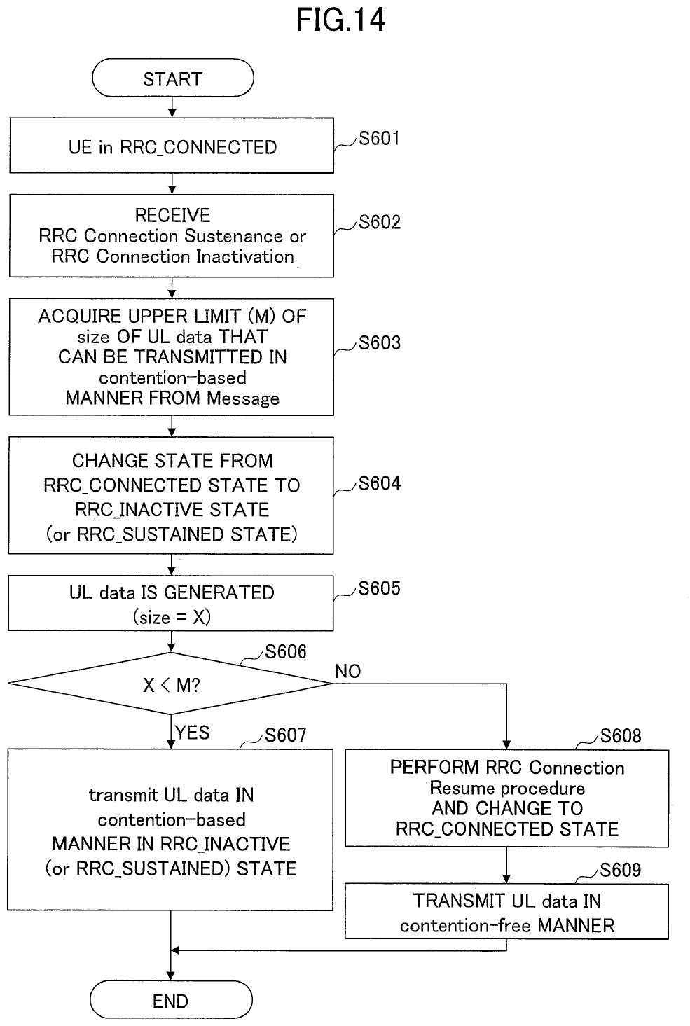

The determination in Step S502 of FIG. 13 will be described with reference to the flowchart illustrated in FIG. 14. In FIG. 14, for convenience, the user equipment 100 is represented by “UE”.

In Step S601, the user equipment 100 is in the RRC_CONNECTED state. In Step S602, the user equipment 100 receives an RRC connection inactivation message (RRC connection sustenance message) including the upper limit (M) from the base station 200.

In Step S603, the user equipment 100 acquires the upper limit (M) of the size of the UL data, which can be transmitted in a contention-based manner, from the message received in Step S602. In Step S604, the user equipment 100 changes its own state from the RRC_CONNECTED state to the RRC_INACTIVE state (RRC_SUSTAINED state).

In Step S605, UL data is generated in the user equipment 100. It is assumed that the size of the UL data is X. In Step S606, the user equipment 100 determines whether the size of the UL data is less than the upper limit (whether X<M is satisfied).

When the determination result in Step S606 is “Yes” (X<M is satisfied), the process proceeds to Step S607. In Step S607, the user equipment 100 transmits the UL data in the contention-based manner in the RRC_INACTIVE state (RRC RRC_SUSTAINED state).

When the determination result in Step S606 is “No” (X<M is not satisfied, that is, X>M or X=M is established), the process proceeds to Step S608. In Step S608, the user equipment 100 performs an RRC Connection Resume procedure and changes to the RRC_CONNECTED state. In Step S609, the user equipment 100 performs contention-free UL data transmission. In the determination in Step S606, when X=M is established, the process is branched to “No” and contention-free UL data transmission is performed. However, in Step S606, it may be determined whether X is less than or equal to M. That is, when X=M is established, the process may be branched to “Yes” and contention-based UL data transmission may be performed.

As described above, according to the technique of Example 1, when the size of UL data is small, the user equipment can transmit the UL data, without changing to the RRC_CONNECTED state. Therefore, it is possible to prevent an increase in network load due to unnecessary signaling, to prevent the unnecessary battery consumption of the user equipment 100, and to achieve efficient UL data transmission.

In addition, a technique according to the following Example 2 can be used for the contention-based UL data transmission in Step S607. However, techniques other than the technique according to Example 2 may be used.

### Example 2

Next, an example of a contention-based UL data transmission operation of the user equipment 100 in the RRC_INACTIVE state will be described as Example 2. Example 2 is premised on Example 1. However, the UL data transmission operation described in Example 2 may be performed independently of Example 1. For example, when contention-based UL transmission is determined by a method different from that in Example 1, the UL data transmission operation described in Example 2 may be performed. In addition, it is considered that, when UL data is transmitted, the UL data transmission operation described in Example 2 is always performed, according to the characteristics of an application using the wireless communication system according to this embodiment.

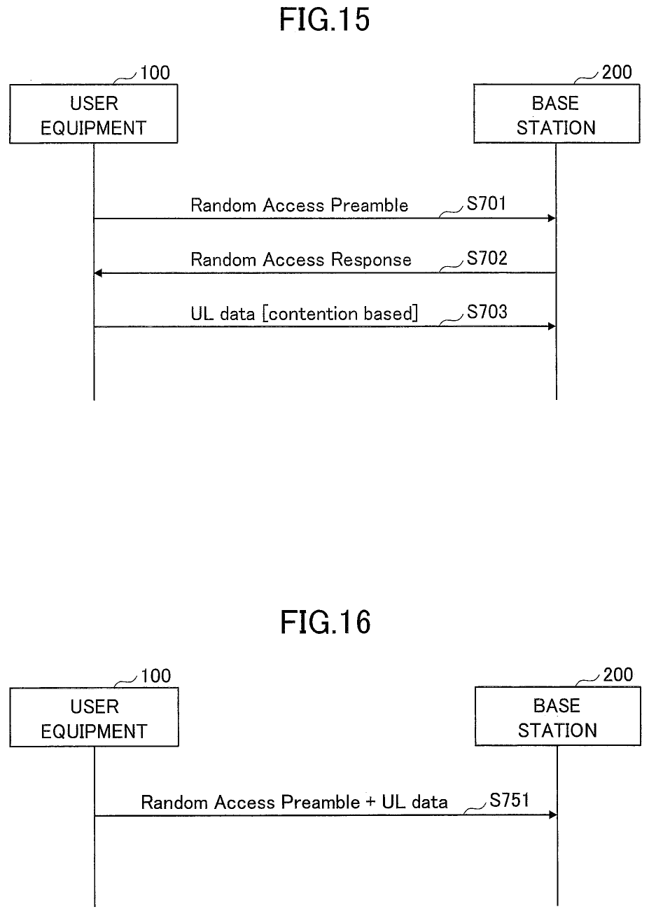

Here, Example 2-1 and Example 2-2 will be described. First, as illustrated in FIG. 15 corresponding to Example 2-1, in Example 2-1, the user equipment 100 performs a random access procedure (Steps S701 and S702) and then transmits UL data (Step S703). However, the random access procedure is different from the random access procedure according to the related art.

In contrast, as illustrated in FIG. 16 corresponding to Example 2-2, in Example 2-2, the user equipment 100 transmits a random access preamble and UL data at the same time (Step S751). Next, Example 2-1 and Example 2-2 will be described in detail.

### Example 2-1

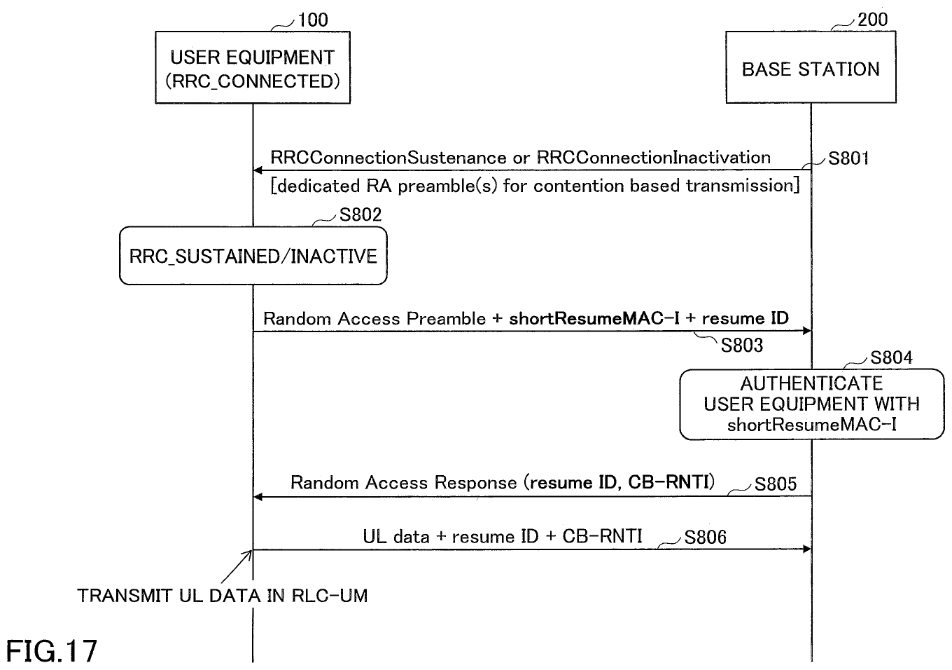

An operation in Example 2-1 will be described in detail with reference to a sequence diagram illustrated in FIG. 17.

First, it is assumed that the user equipment 100 is in the RRC_CNNECTED state. In Step S801, the base station 200 transmits an RRC connection inactivation message (RRC connection sustenance message) to the user equipment 100. In Step S802, the state of the user equipment 100 is changed from the RRC_CONNECTED state to the RRC_INACTIVE state (RRC_SUSTAINED state).

The message transmitted from the base station 200 to the user equipment 100 in Step S801 includes one or a plurality of dedicated random access preambles for contention-based data transmission. The user equipment 100 uses the dedicated random access preamble in Step S803 which will be described below. In this way, it is possible to prevent the random access preamble transmitted for contention-based data transmission from contending with the existing random access preamble. However, the use of the dedicated random access preamble is just an example and a random access preamble selected from the existing random access preambles (for example, 64 random access preambles) may be used. In this case, the dedicated random access preamble may not be included in the message transmitted in Step S801. When the dedicated random access preamble is used, the message by which the dedicated random access preamble is transmitted from the base station 200 to the user equipment 100 may be a message other than the RRC connection inactivation message (RRC connection sustenance message).

In Step S803, the user equipment 100 transmits the random access preamble, an identifier that is used by the base station 200 to authenticate the user equipment 100, and an identifier for specifying the AS context of the user equipment 100 to the base station 200.

As illustrated in FIG. 17, the identifier for authenticating the user equipment 100 is shortResumeMAC-I defined in LTE. However, the use of shortResumeMAC-I is just an example and identifiers other than shortResumeMAC-I may be used. In addition, the identifier for specifying the AS context of the user equipment 100 is a resume ID. However, the use of the resume ID is just an example and identifiers other than the resume ID may be used. The data transmitted In Step S803 may not include the resume ID. In this case, the base station 200 acquires the resume ID associated with the authenticated user equipment 100 from, for example, a storage means of the base station 200.

In addition, resources for transmitting “the random access preamble+shortResumeMAC-I+the resume ID” in Step S803 may be PRACH resources defined in LTE or resources other than the PRACH resources.

In Step S804 of FIG. 17, the base station 200 authenticates the user equipment 100 using an identifier for authentication (shortResumeMAC-I in this example). Here, it is assumed that authentication has succeeded.

In Step S805, the base station 200 that has authenticated the user equipment 100 using shortResumeMAC-I transmits Random Access Response including the resume ID received in Step S803 and RNTI (which is also referred to as CB-RNTI) that is an identifier for contention-based transmission to the user equipment 100.

For example, only one CB-RNTI may be defined by the specifications of the standard. Alternatively, a plurality of CB-RNTIs may be defined and different CB-RNTIs may be allocated to the user equipments. When different CB-RNTIs may be allocated to the user equipments, the CB-RNTI is an identifier for identifying contention-based transmission and is an identifier for identifying the user equipment. The data transmitted in Step S805 may not include the resume ID. In this case, for example, the user equipment 100 may determine that the authentication by the base station 200 has succeeded by receiving Random Access Response, within a predetermined time window, after the message is transmitted in Step S803, and perform UL data transmission. However, when the resume ID is not included, the possibility that the user equipment 100 will mistake a random access response addressed to another user equipment for a random access response addressed to the user equipment 100 is high. Therefore, it is preferable that the resume ID is included.

When the user equipment 100 receives the random access response transmitted in Step S805 and detects the resume ID of the user equipment 100 in the random access response, the user equipment 100 transmits UL data, the resume ID, and the CB-RNTI received in Step S805 in Step S806. In this example, UL data transmission is performed in RLC-UM in the RLC layer. However, this is just an example and UL data may be transmitted in other modes (for example, TM). In Step S806, the resume ID may not be included. In Step S806, the UL data is transmitted using the resource instructed by the random access response transmitted in Step S805. However, the resource is not an individual resource, but is a resource that is likely to cause contention. In addition, the resource may not be instructed by the random access response transmitted in Step S805. In this case, for example, the user equipment 100 performs transmission using a resource selected from the resources in a predetermined range. When the user equipment 100 receives the random access response transmitted in Step S805 and is not capable of detecting its own resume ID from the random access response, the user equipment 100 does not perform the UL data transmission in Step S806.

After Step S806, for example, when the base station 200 normally receives the UL data, ACK is transmitted from the base station 200 to the user equipment 100. When the base station 200 is not capable of normally receiving the UL data (for example, when the base station 200 has failed in decoding the UL data), NACK is transmitted from the base station 200 to the user equipment 100. When the user equipment 100 receives NACK, the user equipment 100 retransmits the UL data as in, for example, Step S806. However, the transmission of ACK/NACK from the base station 200 to the user equipment 100 and the retransmission of the UL data may not be performed.

### Example 2-2

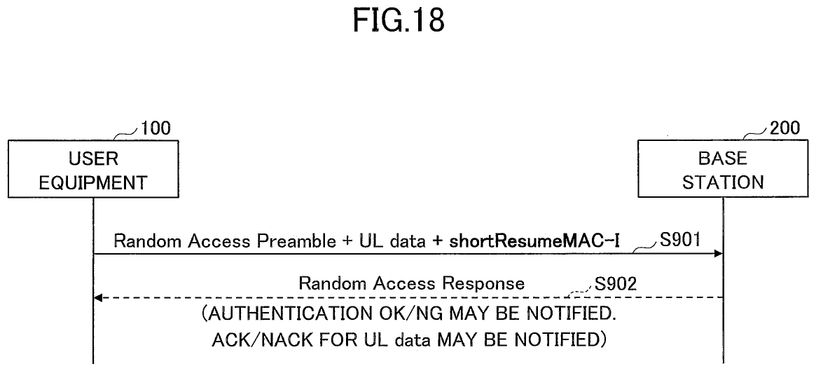

Next, an operation in Example 2-2 will be described in detail with reference to a sequence diagram illustrated in FIG. 18. In the example illustrated in FIG. 18, it is assumed that the user equipment 100 is in the RRC_INACTIVE state (RRC_SUSTAINED state).

Similarly to Example 2-1, when transition from the RRC_CONNCTED state to the RRC_INACTIVE state is performed, an RRC connection inactivation message (RRC connection sustenance message) including a dedicated random access preamble for contention-based data transmission may be transmitted from the base station 200 to the user equipment 100 and the user equipment 100 may use the dedicated random access preamble in the following process. In addition, the user equipment 100 may not use the dedicated random access preamble, but may use the existing random access preamble.

In Step S901 of FIG. 18, the user equipment 100 transmits the random access preamble, UL data, and an identifier (in this example, shortResumeMAC-I is used) that is used by the base station 200 to authenticate the user equipment 100 to the base station 200.

In Step S901, a UL data transmission process ends. However, a process in Step S902 may be optionally performed. In Step S902, the base station 200 returns a random access response to the user equipment 100. The random access response includes, for example, authentication OK/NG, ACK/NACK for UL data, or both authentication OK/NG and ACK/NACK for UL data. Here, when the user equipment 100 receives NACK, the user equipment 100 can retransmit the UL data as in Step S901.

Resources for transmitting “the random access preamble+the UL data+shortResumeMAC-I” in Step S901 may be PRACH resources defined in LTE or resources other than the PRACH resources. In addition, a portion of the sequence of the random access preamble may be UL data. The data transmitted in Step S901 may include a resume ID, in addition to “the random access preamble+the UL data+shortResumeMAC-I”.

According to Example 2 (2-1 and 2-2), UL data transmission is performed using the random access procedure. Therefore, the user equipment can effectively perform UL data transmission in the intermediate state, without changing to the RRC_CONNECTED state.

### Example 3

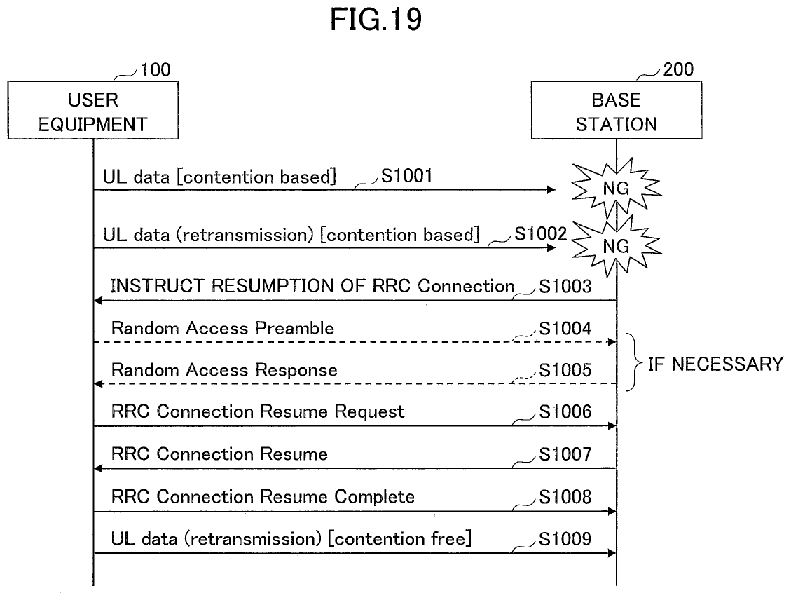

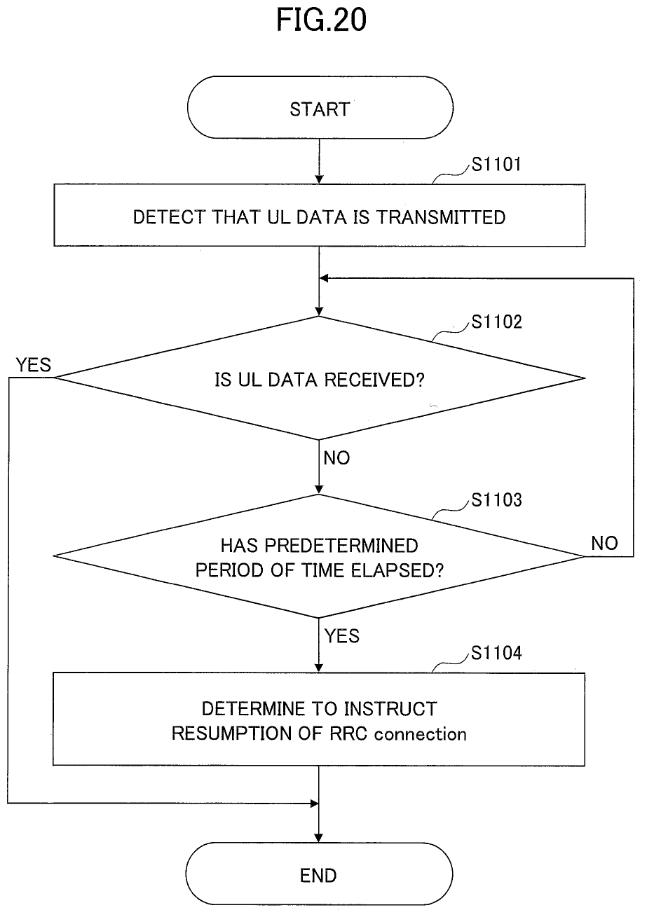

As described above, it is considered that, in some cases, even when the user equipment 100 performs contention-based UL data transmission (including retransmission) in the RRC_INACTIVE state (RRC_SUSTAINED state), data transmission fails (the base station 200 is not capable of normally receiving UL data). In Example 3, in this case, the base station 200 instructs the user equipment 100 to perform contention-free retransmission. Next, an example of an operation in Example 3 will be described in detail with reference to a sequence diagram illustrated in FIG. 19 and a flowchart illustrated in FIG. 20. Example 3 is premised on Example 2. However, a technique according to Example 3 may be performed independently of Example 2. For example, when contention-based UL data transmission is performed by a method other than the methods illustrated in FIGS. 17 and 18, the operation according to Example 3 illustrated in FIG. 19 may be applied.

In FIG. 19, the user equipment 100 is in the RRC_INACTIVE state (RRC_SUSTAINED state) at the beginning. In Steps S1001 and S1002 of FIG. 19, the user equipment 100 performs contention-based UL data transmission, fails in transmitting UL data, and fails in retransmitting the UL data. FIG. 19 illustrates one retransmission operation (S1002). However, retransmission may be performed a plurality of times. In addition, retransmission may not be performed.

After Step S1002, when the base station 200 detects that the user equipment 100 has failed in contention-based UL data transmission, the base station 200 instructs the user equipment 100 to resume an RRC connection in Step S1003. Then, if necessary (for example, when UL synchronization is not established), the user equipment 100 performs the transmission of a random access preamble and the reception of a random access response (Steps S1004 and S1005) and transmits an RRC connection resume request (Step S1006). The user equipment 100 receives RRC Connection Resume transmitted from the base station 200 (Step S1007) and transmits RRC Connection Resume Complete (Step S1008). At that time, the user equipment 100 is in the RRC_CONNECTED state. Then, in Step S1009, the user equipment 100 performs contention-free UL data transmission.

<For Instruction in Step S1003>

In Step S1003, for example, a physical downlink control channel (PDCCH (UL grant)) can be used as an instruction for the user equipment 100 to resume an RRC connection which is issued from the base station 200. In this case, for example, in Step S1003, the base station 200 instructs the user equipment 100 to resume an RRC connection, using one bit in the PDCCH.

In addition, MAC CE that instructs the resumption of an RRC connection may be newly defined. In this case, in Step S1003, the base station 200 creates the MAC CE and transmits the MAC CE to the user equipment 100.

In Step S1003, the base station 200 may transmit an RLC status report to instruct the user equipment 100 to resume an RRC connection.

<For Determination of Transmission of Instruction to Resume RRC Connection>

The base station 200 may use any method for detecting that the user equipment 100 has failed in contention-based UL data transmission and determining to instruct the resumption of an RRC connection. For example, a method illustrated in FIG. 20 can be used.

In the method illustrated in FIG. 20, for example, it is assumed that the user equipment 100 transmits UL data using the procedure illustrated in FIG. 17 (the procedure according to Example 2-1). In addition, the base station 200 includes a timer for measuring a predetermined period of time which will be described below.

In Step S1101 of FIG. 20, the base station 200 receives “the random access preamble+shortResumeMAC-I+the resume ID” (Step S803 in FIG. 17) and detects that UL data is received from the user equipment 100 in a contention-based manner after this point of time.

The detection (the start of the timer) in Step S1101 may be performed by the transmission of a random access response (Step S805 in FIG. 17) by the base station 200.

At the time of the detection (the reception of “the random access preamble+shortResumeMAC-I+the resume ID” or the transmission of the random access response) in Step S1101, the base station 200 starts the timer for measuring a predetermined period of time.

In Step S1102, the base station 200 determines whether the UL data has been normally received from the user equipment 100. When the UL data has been received (Yes), the base station 200 ends the process. When the UL data has not been received (No), the process proceeds to Step S1103. In Step S1103, the base station 20 determines whether a predetermined period of time has elapsed (whether the timer has expired). When a predetermined period of time has not elapsed (No), the process returns to Step S1102. In Step S1103, when a predetermined period of time has elapsed (Yes), the process proceeds to Step S1104. In Step S1104, the base station 200 detects that the user equipment 100 has failed in contention-based UL data transmission and determines to instruct the resumption of an RRC connection.

According to Example 3, it is possible to prevent the user equipment 100 from repeating unnecessary contention-based UL data retransmission and to achieve effective UL data transmission.

(Structure of Devices)

An example of the functional structure of the user equipment 100 and the base station 200 that perform the operations according to this embodiment will be described. In Example 1, Example 2, and Example 3, each of the user equipment 100 and the base station 200 may have the functions according to any one of Example 1, Example 2, and Example 3, may have the functions according to two examples, or may have the functions according to three examples. In the following description, it is assumed that each of the user equipment 100 and the base station 200 has the functions according to three examples.

<User Equipment 100>

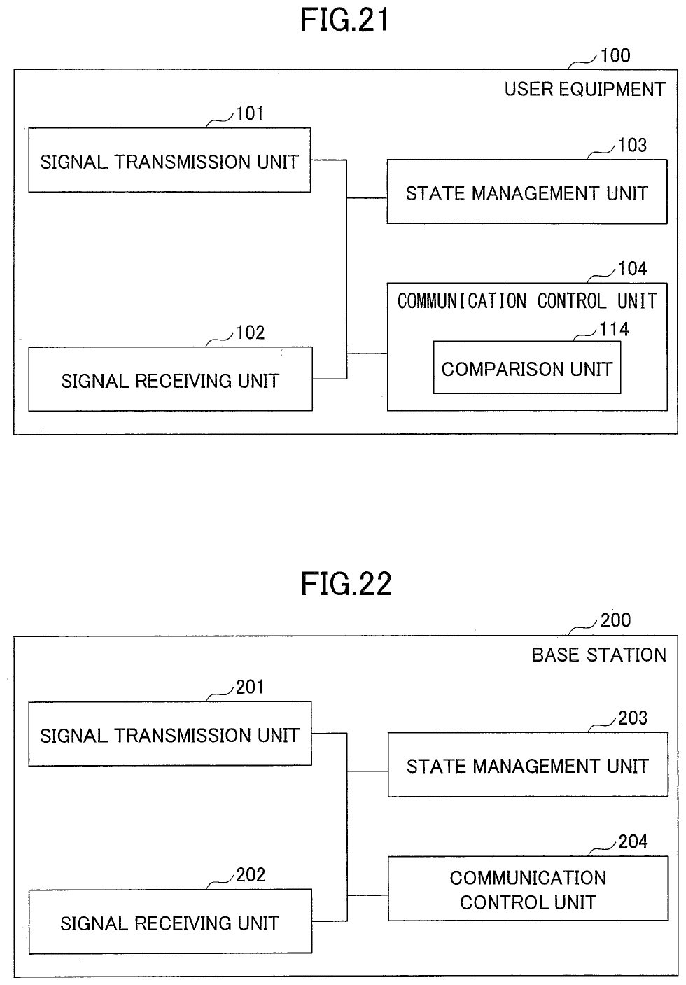

FIG. 21 is a diagram illustrating an example of the functional structure of the user equipment 100. As illustrated in FIG. 21, the user equipment 10 includes a signal transmission unit 101, a signal receiving unit 102, a state management unit 103, and a communication control unit 104. The communication control unit 104 includes a comparison unit 114. When the user equipment 100 does not have the functions according to Example 1, the comparison unit 114 may not be provided. The functional structure illustrated in FIG. 21 is just an example. The functional units may be classified in any way or may have any names as long as they can perform the operations according to this embodiment. For example, the communication control unit 104 may be separately provided on the reception side and the transmission side. The signal transmission unit 101 may include a transmission-side communication control unit 104 and the signal receiving unit 102 may include a reception-side communication control unit 104.

The signal transmission unit 101 converts data to be transmitted from the user equipment 100 into a radio signal and wirelessly transmits the signal. The signal receiving unit 102 wirelessly receives various signals and acquires data from the received signals.

The state management unit 103 changes the states described in this embodiment and manages (retains) the current state. The communication control unit 104 acquires various identifiers (for example, the resume ID, the identifier for authentication, and RNTI), retains the identifiers, and transmits identifiers required for UL data transmission to the signal transmission unit 101. In addition, the communication control unit 104 can acquire the AS context, retain the AS context, and instruct the signal transmission unit 101/the signal receiving unit 102 to transmit/receive signals, on the basis of the AS context.

The communication control unit 104 acquires the upper limit, retains the upper limit, and performs the determination operation illustrated in FIG. 14. In this case, when uplink data is generated in the user equipment 100 in the intermediate state, the comparison unit 114 that compares the size of the uplink data with a predetermined upper limit is used.

When the comparison unit 114 determines that the size of the uplink data is less than the predetermined upper limit, the signal transmission unit 101 may transmit the uplink data to the base station 200 in the contention-based manner. When the comparison unit 114 determines that the size of the uplink data is greater than the predetermined upper limit, the signal transmission unit 101 may transmit the uplink data to the base station 100 in the contention-free manner.

The signal receiving unit 102 receives a message that includes the predetermined upper limit and instructs state transition from the connected state to the intermediate state from the base station 200. The comparison unit 114 may acquire the predetermined upper limit from the message and compare the size of the unlink data with the predetermined upper limit.

When uplink data is transmitted in the contention-based manner, the signal transmission unit 101 may transmit a random access preamble, an identifier that is used by the base station 200 to authenticate the user equipment 100, and an identifier for identifying the context of the user equipment 100 to the base station 200 and may transmit the uplink data and an identifier that indicates contention-based transmission and is received from the base station 200 to the base station 200.

In addition, when uplink data is transmitted in the contention-based manner, the signal transmission unit 101 may transmit a random access preamble, the uplink data, and an identifier that is used by the base station 200 to authenticate the user equipment 100 to the base station 200.

When the contention-based transmission of the uplink data to the base station 200 has failed, the user equipment 100 may change from the intermediate state to the connected state, in response to the reception of a signal for instructing transition from the intermediate state to the connected state from the base station 200, and the signal transmission unit 101 may transmit the uplink data to the base station 200 in the contention-free manner.

<Base Station 200>

FIG. 22 is a diagram illustrating an example of the functional structure of the base station 200. As illustrated in FIG. 22, the base station 200 includes a signal transmission unit 201, a signal receiving unit 202, a state management unit 203, and a communication control unit 204. The functional structure illustrated in FIG. 22 is just an example. The functional units may be classified in any way or may have any names as long as they can perform the operations according to this embodiment. For example, the communication control unit 204 may be separately provided on the reception side and the transmission side. The signal transmission unit 201 may include a transmission-side communication control unit 204 and the signal receiving unit 202 may include a reception-side communication control unit 204.

The signal transmission unit 201 converts data to be transmitted from the base station 200 into a radio signal and wirelessly transmits the signal. The signal receiving unit 202 wirelessly receives various signals and acquires data from the received signals.

The state management unit 203 performs transition between the states described in this embodiment and manages (retains) the current state. The communication control unit 204 acquires (including generation) various identifiers (for example, the resume ID, the identifier for authentication, and RNTI), retains the identifiers, and transmits identifiers required for DL message transmission to the signal transmission unit 201. In addition, the communication control unit 204 can acquire the AS context of the user equipment 100, retain the AS context, and instruct the signal transmission unit 201/the signal receiving unit 202 to transmit/receive signals between the user equipment 100 and the base station 200, on the basis of the AS context. In addition, the communication control unit 204 can authenticate the user equipment 100, using the identifier for authentication.

When uplink data is generated in the user equipment in the intermediate state and is transmitted in the contention-based manner, the signal receiving unit 202 may receive the random access preamble, the identifier that is used by the base station 200 to authenticate the user equipment 100, and the identifier for identifying the context of the user equipment 100 from the user equipment 100. The signal transmission unit 201 may transmit a random access response including the identifier for identifying the context and an identifier indicating contention-based transmission to the user equipment 100. The signal receiving unit 202 may receive the identifier indicating contention-based transmission and the uplink data from the user equipment 100.

When it is detected that the reception of the uplink data transmitted from the user equipment 100 in the intermediate state in the contention-based manner has failed, the signal transmission unit 201 may transmit a signal for instructing transition from the intermediate state to the connected state to the user equipment 100. The signal receiving unit 202 may receive the uplink data transmitted from the user equipment 100, which has been changed to the connected state, in the contention-free manner, on the basis of the signal transmitted by the signal transmission unit 201.

<Hardware Configuration>

The block diagrams (FIGS. 21 and 22) used to describe the above-mentioned embodiment illustrate functional unit blocks. The functional blocks (components) are implemented by an arbitrary combination of hardware and/or software. In addition, a means for implementing each functional block is not particularly limited. That is, each functional block may be implemented by one device in which a plurality of elements are physically and/or logically coupled or by a plurality of devices that are physically and/or logically separated from each other and are connected directly and/or indirectly (for example, in a wired manner and/or wirelessly).

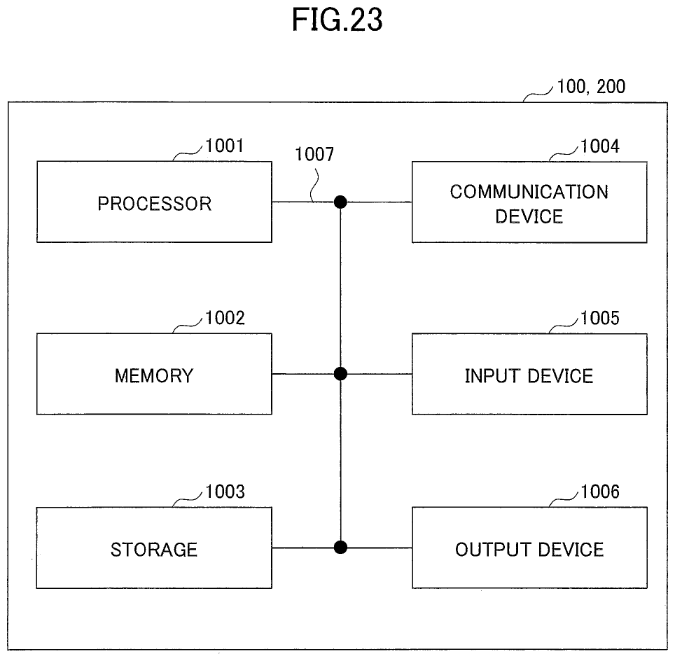

For example, each of the user equipment 100 and the base station 200 according to the embodiment of the invention may function as a computer that performs the processes according to this embodiment. FIG. 23 is a diagram illustrating an example of the hardware configuration of the user equipment 100 and the base station 200 according to this embodiment. Each of the user equipment 100 and the base station 200 may be physically configured as a computer device including, for example, a processor 1001, a memory 1002, a storage 1003, a communication device 1004, an input device 1005, an output device 1006, and a bus 1007.

In the following description, the term “device” can be substituted with, for example, a circuit, an apparatus, and a unit. The hardware configuration of the user equipment 100 and the base station 200 may include one or a plurality of devices represented by reference numerals 1001 to 1006 in FIG. 23 or may not include some of the devices.

Each function of the user equipment 100 and the base station 200 may be implemented by the following process: predetermined software (program) is read onto hardware, such as the processor 1001 or the memory 1002, and the processor 1001 performs an operation to control the communication of the communication device 1004 or the reading and/or writing of data from and/or to the memory 1002 and the storage 1003.

The processor 1001 operates, for example, an operating system to control the overall operation of the computer. The processor 1001 may be a central processing unit (CPU) including, for example, an interface with peripheral devices, a control device, an arithmetic device, and a register.

The processor 1001 reads a program (program code), a software module, or data from the storage 1003 and/or the communication device 1004 to the memory 1002 and performs various types of processes according to the program, the software module, or the data. A program that causes a computer to perform at least some of the operations described in the embodiment is used as the program. For example, the signal transmission unit 101, the signal receiving unit 102, the state management unit 103, and the communication control unit 104 of the user equipment 100 may be implemented by a control program that is stored in the memory 1002 and is executed by the processor 1001. The signal transmission unit 201, the signal receiving unit 202, the state management unit 203, and the communication control unit 204 of the base station 20 may be implemented by a control program that is stored in the memory 1002 and is executed by the processor 1001. In the embodiment, the above-mentioned various processes are performed by one processor 1001. However, the processes may be simultaneously or sequentially performed by two or more processors 1001. The processor 1001 may be mounted with one or more chips. The program may be transmitted from the network through an electric communication line.

The memory 1002 is a computer-readable recording medium and may include, for example, at least one of a read only memory (ROM), an erasable programmable ROM (EPROM), an electrically erasable programmable ROM (EEPROM), and a random access memory (RAM). The memory 1002 may also be referred to as, for example, a register, a cache, or a main memory (main storage device). The memory 1002 can store, for example, a program (program code) and a software module that can be executed to perform the processes according to an embodiment of the invention.

The storage 1003 is a computer-readable recording medium and may include, for example, at least one of an optical disk, such as a compact disc ROM (CD-ROM), a hard disk drive, a flexible disk, a magneto-optical disk (for example, a compact disc, a digital versatile disc, or a Blu-ray (registered trademark) disc), a smart card, a flash memory (for example, a card, a stick, or a key drive), a floppy (registered trademark) disk, and a magnetic strip. The storage 1003 may also be referred to as an auxiliary storage device. The above-mentioned storage medium may be, for example, a database, a server, and other proper media including the memory 1002 and/or the storage 1003.

The communication device 1004 is hardware (transmitting and receiving device) for communicating with the computer through a wired and/or wireless network and is also referred to as, for example, a network device, a network controller, a network card, or a communication module. For example, the signal transmission unit 101 and the signal receiving unit 102 of the user equipment 100 may be implemented by the communication device 1004. The signal transmission unit 201 and the signal receiving unit 202 of the base station 200 may be implemented by the communication device 1004.

The input device 1005 is an input unit (for example, a keyboard, a mouse, a microphone, a switch, a button, or a sensor) that receives an input from the outside. The output device 1006 is an output unit (for example, a display, a speaker, or an LED lamp) that performs an output process to the outside. The input device 1005 and the output device 1006 may be integrated with each other (for example, a touch panel).

The devices, such as the processor 1001 and the memory 1002, are connected to each other by the bus 1007 for information communication. The bus 1007 may be a single bus or the devices may be connected to each other by different buses.

Each of the user equipment 100 and the base station 200 may include hardware, such as a microprocessor, a digital signal processor (DSP), an application specific integrated circuit (ASIC), a programmable logic device (PLD), and a field programmable gate array (FPGA), or some or all of the functional blocks may be implemented by the hardware. For example, the processor 1001 may be mounted with at least one of these hardware components.

### Summary of Embodiment

As described above, according to this embodiment, there is provided a user equipment that is used in a wireless communication system supporting an intermediate state between a connected state and an idle state. The user equipment includes a comparison unit that, when uplink data is generated in the user equipment in the intermediate state, compares a size of the uplink data with a predetermined upper limit and a transmitting unit that transmits the uplink data to a base station in a contention-based manner when the comparison unit determines that the size of the uplink data is less than the predetermined upper limit and transmits the uplink data to the base station in a contention-free manner when the comparison unit determines that the size of the uplink data is greater than the predetermined upper limit.

According to the above-mentioned structure, when UL data is generated in the user equipment in the intermediate state between the connected state and the idle state, the user equipment can efficiently transmit the UL data.

The user equipment may further include a receiving unit that receives a message which includes the predetermined upper limit and instructs a state transition from the connected state to the intermediate state from the base station. The comparison unit may acquire the predetermined upper limit from the message and compare the predetermined upper limit with the size of the uplink data. According to this structure, for example, the user equipment can receive an appropriate upper limit corresponding to a communication environment and/or communication conditions from the base station and can transmit UL data with an appropriate size in the contention-based manner, using the upper limit.

When the uplink data is transmitted in the contention-based manner, the transmitting unit may transmit a random access preamble, an identifier which is used by the base station to authenticate the user equipment, and an identifier for identifying a context of the user equipment to the base station and transmit the uplink data and an identifier indicating contention-based transmission, which is received from the base station, to the base station. According to this structure, the user equipment can effectively transmit UL data, using the random access procedure, without changing to the connected state.

When the uplink data is transmitted in the contention-based manner, the transmitting unit may transmit a random access preamble, the uplink data, and an identifier which is used by the base station to authenticate the user equipment to the base station. According to this structure, the user equipment can effectively transmit UL data, using the random access procedure, without changing to the connected state.

When the contention-based transmission of the uplink data to the base station has failed, the user equipment may change from the intermediate state to the connected state in response to the reception of a signal for instructing a transition from the intermediate state to the connected state from the base station and the transmitting unit may transmit the uplink data to the base station in the contention-free manner. According to this structure, it is possible to prevent the user equipment from repeating unnecessary contention-based retransmission and the user equipment can effectively transmit UL data.

### Other Examples

According to this embodiment, there is provided a user equipment that is used in a wireless communication system supporting an intermediate state between a connected state and an idle state. The user equipment includes: a transmitting unit that, when uplink data is generated in the user equipment in the intermediate state and is transmitted in a contention-based manner, transmits a random access preamble, an identifier which is used by the base station to authenticate the user equipment, and an identifier for identifying a context of the user equipment to the base station; and a receiving unit that receives a random access response including the identifier for identifying the context and an identifier indicating contention-based transmission from the base station. The transmitting unit transmits the uplink data and the identifier indicating contention-based transmission to the base station.

According to this embodiment, there is provided a base station that is used in a wireless communication system supporting an intermediate state between a connected state and an idle state. The base station includes: a receiving unit that, when uplink data is generated in a user equipment in the intermediate state and is transmitted in a contention-based manner, receives a random access preamble, an identifier which is used by the base station to authenticate the user equipment, and an identifier for identifying a context of the user equipment from the user equipment; and a transmitting unit that transmits a random access response including the identifier for identifying the context and an identifier indicating contention-based transmission to the user equipment. The receiving unit receives the uplink data and the identifier indicating contention-based transmission from the user equipment.

According to this embodiment, there is provided a user equipment that is used in a wireless communication system supporting an intermediate state between a connected state and an idle state. The user equipment includes: a transmitting unit that, when uplink data is generated in the user equipment in the intermediate state and is transmitted in a contention-based manner, transmits a random access preamble, the uplink data, and an identifier which is used by the base station to authenticate the user equipment to the base station.

According to this embodiment, there is provided a user equipment that is used in a wireless communication system supporting an intermediate state between a connected state and an idle state. The user equipment includes: a transmitting unit that, when uplink data is generated in the user equipment in the intermediate state, transmits the uplink data in a contention-based manner; and a receiving unit that, when the transmission of the uplink data to the base station has failed, receives a signal for instructing a transition from the intermediate state to the connected state from the base station. After the user equipment changes to the connected state on the basis of the signal received by the receiving unit, the transmitting unit transmits the uplink data to the base station in a contention-free manner.

According to this embodiment, there is provided a base station that is used in a wireless communication system supporting an intermediate state between a connected state and an idle state. The base station includes: a transmitting unit that, when it is detected that the reception of uplink data transmitted from a user equipment in a contention-based manner has failed, transmits a signal for instructing a transition from the intermediate state to the connected state to the user equipment; and a receiving unit that receives the uplink data transmitted from the user equipment in a contention-free manner after the user equipment changes to the connected state on the basis of the signal transmitted by the transmitting unit.

According to the user equipment and the base station described in <Other Examples>, when UL data is generated in the user equipment in the intermediate state between the connected state and the idle state, the user equipment can effectively transmit the UL data.

### Supplementary Description of Embodiment

The embodiment of the invention has been described above. However, the disclosed invention is not limited to the embodiment and it will be understood by those skilled in the art that various variations, modifications, alterations, and substitutions can be made. Specific numerical examples are used to facilitate the understanding of the invention. However, the numerical values are just examples and any appropriate values may be used, unless otherwise stated. The classification of the items in the above-mentioned description is not essential in the invention and matters described in two or more items may be combined and used, if necessary. Matters described in an item may be applied to matters described in another item (as long as they do not contradict each other). The boundaries between the functional units or the processing units in the functional block diagram do not necessarily correspond to the boundaries between physical components. The operation of a plurality of functional units may be physically performed by one component. Alternatively, the operation of one functional unit may be physically performed by a plurality of components. In the procedures described in the embodiment, the order of the processes may be changed as long as there is no contradiction between the processes. For convenience of description of the processes, the user equipment 100 and the base station 200 have been described, using the functional block diagrams. However, the devices may be implemented by hardware, software, or a combination thereof. The software that is operated by the processor included in the user equipment 100 according to the embodiment of the invention and the software that is operated by the processor included in the base station 200 according to the embodiment of the invention may be stored in a random access memory (RAM), a flash memory, a read only memory (ROM), an EPROM, an EEPROM, a register, a hard disk (HDD), a removable disk, a CD-ROM, a database, a server, and other proper storage media.

The notification of information is not limited to the aspects/embodiments described in the specification and may be performed by other methods. For example, the notification of information may be performed by physical layer signaling (for example, downlink control information (DCI) and uplink control information (UCI)), higher layer signaling (for example, radio resource control (RRC) signaling, medium access control (MAC) signaling, and broadcast information (a master information block (MIB) and a system information block (SIB))), other signals, or combinations thereof. The RRC signaling may also be referred to as an RRC message and may be, for example, an RRC connection setup message or an RRC connection reconfiguration message.

Each aspect/embodiment described in the specification may be applied to systems using Long Term Evolution (LTE), LTE-Advanced (LTE-A), SUPER 3G, IMT-Advanced, 4G, 5G, Future Radio Access (FRA), W-CDMA (registered trademark), GSM (registered trademark), CDMA2000, Ultra Mobile Broadband (UMB), IEEE 802.11 (Wi-Fi), IEEE 802.16 (WiMAX), IEEE 802.20, Ultra-WideBand (UWB), Bluetooth (registered trademark), and other proper systems and/or next-generation systems that are extended on the basis of these systems.

In each aspect/embodiment described in the specification, for example, the order of the processes in the procedure, the sequence, and the flowchart may be changed as long as there is no contraction between the processes. For example, for the method described in the specification, elements of various steps are presented in the exemplified order. However, the invention is not limited to the presented specific order.

In the specification, in some cases, a specific operation performed by the base station 200 is performed by an upper node of the base station. In a network having one or a plurality of network nodes including the base station 200, it is apparent that various operations performed for communication with the user equipment 100 can be performed by the base station 200 and/or a network node (for example, MME or S-GW is considered and the network node is not limited thereto) other than the base station 200. In the above-described embodiments, one network node is provided other than the base station 200. However, a plurality of other network nodes (for example, MME and S-GW) may be combined with each other.

The aspects/embodiments described in the specification may be independently used, may be combined with each other, or may be changed in association with execution.

In some cases, the user equipment 100 is referred to as a subscriber station, a mobile unit, a subscriber unit, a wireless unit, a remote unit, a mobile device, a wireless device, a wireless communication device, a remote device, a mobile subscriber station, an access terminal, a mobile terminal, a wireless terminal, a remote terminal, a handset, a user agent, a mobile client, a client, or some other proper terms according to operators.

In some cases, the base station 200 is referred to as NodeB (NB), enhanced NodeB (eNB), a base station, or some other proper terms according to operators.

In some cases, the terms “determining” and “determining” used in the specification include various operations. The terms “determining” and “deciding” can include, for example, “determination” and “decision” for judging, calculating, computing, processing, deriving, investigating, looking-up (for example, looking-up in a table, a database, or other data structures), and ascertaining operations. In addition, the terms “determining” and “deciding” can include “determination” and “decision” for receiving (for example, information reception), transmitting (for example, information transmission), input, output, and accessing (for example, accessing data in a memory) operations. The terms “determining” and “deciding” can include “determination” and “decision” for resolving, selecting, choosing, establishing, and comparing operations. That is, the terms “determining” and “deciding” can include “determination” and “decision” for any operation.

The term “on the basis of” used in the specification does not mean “on the basis of only” unless otherwise stated. In other words, the term “on the basis of” means both “on the basis of only” and “on the basis of at least”.

The terms “include” and “including” and the modifications thereof are intended to be inclusive, similarly to the term “comprising”, as long as they are used in the specification or the claims. In addition, the term “or” used in the specification or the claims does not mean exclusive OR.

In the entire disclosure, for example, when an article, such as “a”, “an”, or “the”, in English is added by translation, the article can include the meaning of the plural as long as it does not clearly indicate the single number in context.

The invention has been described in detail above. It will be apparent to those skilled in the art that the invention is not limited to the embodiments described in the specification. Various modifications and changes of the invention can be made, without departing from the scope and spirit of the invention described in the claims. Therefore, the embodiments described in the specification are illustrative and do not limit the invention.

The present patent application claims priority based on Japanese patent application No. 2016-192358, filed in the JPO on Sep. 29, 2016, and the entire contents of the Japanese patent application No. 2016-192358 are incorporated herein by reference.

### EXPLANATIONS OF LETTERS OR NUMERALS

100 user equipment
200 base station
101 signal transmission unit
102 signal receiving unit
103 state management unit
104 communication control unit
114 comparison unit
201 signal transmission unit
202 signal receiving unit
203 state management unit
204 communication control unit
1001 processor
1002 memory
1003 storage
1004 communication device
1005 input device
1006 output device

1. A user equipment that is used in a wireless communication system supporting an intermediate state between a connected state and an idle state, comprising:
a comparison unit that, when uplink data is generated in the user equipment in the intermediate state, compares a size of the uplink data with a predetermined upper limit; and
a transmitting unit that transmits the uplink data to a base station in a contention-based manner when the comparison unit determines that the size of the uplink data is less than the predetermined upper limit and transmits the uplink data to the base station in a contention-free manner when the comparison unit determines that the size of the uplink data is greater than the predetermined upper limit.

2. The user equipment according to claim 1, further comprising:
a receiving unit that receives a message which includes the predetermined upper limit and instructs a state transition from the connected state to the intermediate state from the base station,
wherein the comparison unit acquires the predetermined upper limit from the message and compares the predetermined upper limit with the size of the uplink data.

3. The user equipment according to claim 1,
wherein, when the uplink data is transmitted in the contention-based manner, the transmitting unit transmits a random access preamble, an identifier which is used by the base station to authenticate the user equipment, and an identifier for identifying a context of the user equipment to the base station and transmits the uplink data and an identifier indicating contention-based transmission, which is received from the base station, to the base station.

4. The user equipment according to claim 1,
wherein, when the uplink data is transmitted in the contention-based manner, the transmitting unit transmits a random access preamble, the uplink data, and an identifier which is used by the base station to authenticate the user equipment to the base station.

5. The user equipment according to claim 1,
wherein, when the contention-based transmission of the uplink data to the base station has failed, the user equipment changes from the intermediate state to the connected state in response to the reception of a signal for instructing a transition from the intermediate state to the connected state from the base station and the transmitting unit transmits the uplink data to the base station in the contention-free manner.

6. A data transmission method that is performed by a user equipment in a wireless communication system supporting an intermediate state between a connected state and an idle state, comprising:
a comparison step of, when uplink data is generated in the user equipment in the intermediate state, comparing a size of the uplink data with a predetermined upper limit; and
a transmitting step of transmitting the uplink data to a base station in a contention-based manner when it is determined in the comparison step that the size of the uplink data is less than the predetermined upper limit and transmitting the uplink data to the base station in a contention-free manner when it is determined in the comparison step that the size of the uplink data is greater than the predetermined upper limit.

7. The user equipment according to claim 2,
wherein, when the uplink data is transmitted in the contention-based manner, the transmitting unit transmits a random access preamble, an identifier which is used by the base station to authenticate the user equipment, and an identifier for identifying a context of the user equipment to the base station and transmits the uplink data and an identifier indicating contention-based transmission, which is received from the base station, to the base station.

8. The user equipment according to claim 2,
wherein, when the uplink data is transmitted in the contention-based manner, the transmitting unit transmits a random access preamble, the uplink data, and an identifier which is used by the base station to authenticate the user equipment to the base station.

9. The user equipment according to claim 2,
wherein, when the contention-based transmission of the uplink data to the base station has failed, the user equipment changes from the intermediate state to the connected state in response to the reception of a signal for instructing a transition from the intermediate state to the connected state from the base station and the transmitting unit transmits the uplink data to the base station in the contention-free manner.

10. The user equipment according to claim 3,
wherein, when the contention-based transmission of the uplink data to the base station has failed, the user equipment changes from the intermediate state to the connected state in response to the reception of a signal for instructing a transition from the intermediate state to the connected state from the base station and the transmitting unit transmits the uplink data to the base station in the contention-free manner.

11. The user equipment according to claim 4,
wherein, when the contention-based transmission of the uplink data to the base station has failed, the user equipment changes from the intermediate state to the connected state in response to the reception of a signal for instructing a transition from the intermediate state to the connected state from the base station and the transmitting unit transmits the uplink data to the base station in the contention-free manner.
